(19) United States
(12) Patent Application Publication
(10) Pub. No.: US 2023/0312960 A1
(43) Pub. Date: Oct. 5, 2023

(54) Aqueous Ink Jet Ink

(71) Applicant: SEIKO EPSON CORPORATION, Tokyo (JP)

(72) Inventors: Kenji KITADA, Shiojiri (JP); Takeshi YANO, Fujimi (JP); Shinichi NAITO, Chino (JP); Hiroshi ODAJIMA, Kyoto (JP)

(21) Appl. No.: 18/192,738

(22) Filed: Mar. 30, 2023

(30) Foreign Application Priority Data
Mar. 31, 2022 (JP) 2022-058374

(51) Int. Cl. C09D 11/322; C09D 11/102

(52) U.S. Cl. CPC C09D 11/322; C09D 11/102

(57) ABSTRACT

An aqueous ink jet ink contains a pigment aqueous dispersion, water, and a water-soluble organic solvent. The pigment aqueous dispersion contains a pigment dispersed in a polyurethane resin obtained by reaction of an active hydrogen atom-containing component and an organic polyisocyanate component. The active hydrogen atom-containing component contains a quaternary ammonium compound. The organic polyisocyanate component contains one or more selected from the group consisting of a linear or branched aliphatic polyisocyanate, an alicyclic polyisocyanate, and an aromatic polyisocyanate. The weight rate of the quaternary ammonium compound is 12 wt % or more based on the total weight of the active hydrogen atom-containing component and the organic polyisocyanate component.

The present application is based on, and claims priority from JP Application Serial Number 2022-058374, filed Mar. 31, 2022, the disclosure of which is hereby incorporated by reference herein in its entirety.

### BACKGROUND

### 1. Technical Field

The present disclosure relates to an aqueous ink jet ink.

### 2. Related Art

An ink jet recording method is a method for performing recording by discharging minute droplets of an ink composition from fine nozzles and allowing them to adhere to a recording medium. This method has characteristics that images with high resolution and high quality can be recorded at a high speed with a relatively inexpensive apparatus. The recording media to be used in the ink jet recording method have been developed into absorbent media such as fabric and are becoming more diversified.

For example, JP-A-2018-154829 describes a polyurethane resin-coated pigment water dispersion (R), which is a water dispersion of a pigment (P) that is a pigment (PO) coated with a polyurethane resin (U), wherein the polyurethane resin (U) includes a polyol (A) of one or more selected from the group consisting of a polyester diol (A1), a polycarbonate diol (A2), and a polyether diol (A3); an aliphatic diisocyanate (B1) and/or an alicyclic diisocyanate (B2); and a diol (D) having a carboxyl group and/or a carboxylate anion group as essential constituent monomers, and the total content of the carboxyl group and the carboxylate anion group is 4 to 80 mg/g based on the weight of the polyurethane resin (U).

In an anionic dispersion, the surface layer of a pigment dispersion is negatively charged as shown in JP-A-2018-154829, and there has been a problem of deterioration in color development due to permeation in some surface layer conditions of a base material at the time of printing. Against this, a method using an ammonium salt pigment dispersion using protons is considered, but it has been difficult to ensure dispersion stability in aqueous inks for ink jet.

### SUMMARY

The present inventors made intensive studies to solve the above problems. As a result, dispersion stability and color development property could be increased by adjusting the content of a quaternary ammonium compound within a specific range.

That is, the present disclosure is as follows:

One embodiment of the present disclosure relates to an aqueous ink jet ink containing a pigment aqueous dispersion, water, and a water-soluble organic solvent, wherein
the pigment aqueous dispersion contains a pigment dispersed in a polyurethane resin obtained by reaction of an active hydrogen atom-containing component (A) and an organic polyisocyanate component (B),
the active hydrogen atom-containing component (A) contains a quaternary ammonium compound (a1),
the organic polyisocyanate component (B) contains one or more selected from the group consisting of a linear or branched aliphatic polyisocyanate (b1), an alicyclic polyisocyanate (b2), and an aromatic polyisocyanate (b3), and
the weight rate of the quaternary ammonium compound (a1) is 12 wt % or more based on the total weight of the active hydrogen atom-containing component (A) and the organic polyisocyanate component (B).

In one embodiment of the present disclosure, the quaternary ammonium compound (a1) may be a compound represented by the following formula (1) and/or a compound represented by the following formula (2):

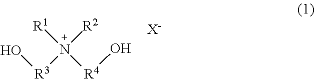

[in formula (1), R¹ and R² are each independently an alkyl group having 1 to 24 carbon atoms, R³ and R⁴ are each independently an alkylene group having 1 to 20 carbon atoms or an oxyalkylene group having 2 to 20 carbon atoms, and X⁻ is an anion]

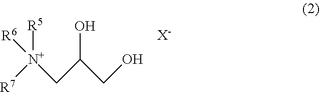

[in formula (2), R⁵, R⁶, and R⁷ are each independently an alkyl group having 1 to 4 carbon atoms, and X⁻ is an anion].

In one embodiment of the present disclosure, the active hydrogen atom-containing component (A) may contain one or more selected from the group consisting of a polycarbonate polyol, a polyester polyol, and a polyether polyol.

In one embodiment of the present disclosure, the polycarbonate polyol may be a crystalline polycarbonate polyol.

In one embodiment of the present disclosure, the water-soluble organic solvent may contain a water-soluble organic solvent having a normal boiling point of 180° C. or more.

In one embodiment of the present disclosure, a surfactant may be further contained.

In one embodiment of the present disclosure, the surfactant may contain a nonionic surfactant.

### DESCRIPTION OF EXEMPLARY EMBODIMENTS

Embodiments (hereinafter, referred to as “the present embodiment”) of the present disclosure will now be described in detail, but the present disclosure is not limited to them, and various modifications are possible without departing from the gist of the disclosure.

The aqueous ink jet ink (hereinafter, simply also referred to as “ink”) according to the present embodiment is an aqueous ink jet ink containing a pigment aqueous dispersion, water, and a water-soluble organic solvent, wherein
the pigment aqueous dispersion contains a pigment dispersed in a polyurethane resin obtained by reaction of an active hydrogen atom-containing component (A) and an organic polyisocyanate component (B),
the active hydrogen atom-containing component (A) contains a quaternary ammonium compound (a1),
the organic polyisocyanate component (B) contains one or more selected from the group consisting of a linear or branched aliphatic polyisocyanate (b1), an alicyclic polyisocyanate (b2), and an aromatic polyisocyanate (b3), and
the weight rate of the quaternary ammonium compound (a1) is 12 wt % or more based on the total weight of the active hydrogen atom-containing component (A) and the organic polyisocyanate component (B).

An ink showing high dispersion stability in a broad pH range ca be obtained by having the composition above.

In the polyurethane resin used in the pigment aqueous dispersion according to the present embodiment, the active hydrogen atom-containing component (A) contains a quaternary ammonium compound (a1). When the quaternary ammonium compound (a1) is contained, pigment aqueous dispersion particles are localized on the surface due to ionic interaction on an absorbent base material such as cloth to improve the existence frequency of the pigment, and as a result, the color development property (=image density) can be improved. In addition, since the quaternary ammonium compound is ionized by a covalent bond of an alkyl group to the nitrogen atom, even if the counter ion is lost, the ionization state is maintained. That is, the pigment aqueous dispersion according to the present embodiment shows dispersion stability even in an environment of a pH of 7 or more and can be materialized as an aqueous ink jet ink.

The quaternary ammonium compound (a1) is a polyatomic ion having a positive charge represented by NR₄⁺ and is not particularly limited as long as it is a compound containing an active hydrogen atom, and examples thereof include reaction product of an active hydrogen atom-containing component containing a tertiary amino group and a quaternizing agent (a1-2).

Examples of the active hydrogen atom-containing component containing a tertiary amino group include a tertiary amino group-containing polyol (a1-1), a tertiary amino group-containing polycarboxylic acid, a tertiary amino group-containing polyamine, a tertiary amino group-containing polyamide, a tertiary amino group-containing polyurethane compound, and a tertiary amino group-containing polyurea compound.

Examples of the tertiary amino group-containing polyol (a1-1) include compounds represented by the following formula (3) and/or the compounds represented by the following formula (4):

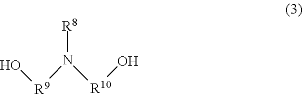

(in formula (3), R⁸ is an alkyl group having 1 to 24 carbon atoms, and R⁹ and R¹⁰ are each independently an alkylene group having 1 to 20 carbon atoms or an oxyalkylene group having 2 to 20 carbon atoms);

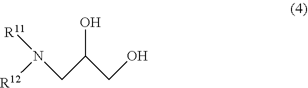

(in formula (4), R¹¹ and R¹² are each independently an alkyl group having 1 to 4 carbon atoms).

Examples of the compound represented by the formula (3) as the tertiary amino group-containing polyol (a1-1) include N-alkyl dialcohol amine and polyoxyalkylene alkylamine.

The term “alkyl” in the present embodiment encompasses linear and branched alkyl groups. The alkyl may be a linear or branched alkyl group having 1 to 24 carbon atoms, a linear or branched alkyl group having 1 to 12 carbon atoms, or a linear or branched alkyl group having 1 to 4 carbon atoms. Examples of the alkyl group particularly include the followings: methyl, ethyl, propyl, isopropyl, n-butyl, 2-butyl, secondary butyl, tertiary butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, n-octyl, 2-ethylhexyl, 2-propylheptyl, nonyl, decyl, undecyl, dodecyl, tridecyl, tetradecyl, pentadecyl, hexadecyl, heptadecyl, octadecyl, nonadecyl, eicosyl, and tetracosyl.

Specific examples of the N-alkyl dialcohol amine and polyoxyalkylene alkylamine include N-methyldiethanolamine, N-ethyldiethanolamine, N-butyldiethanolamine, N-tert-butyldiethanolamine, N-lauryldiethanolamine, N-stearyldiethanolamine, and poly (n=1 to 10) oxyethylene oleylamine.

Examples of the compound represented by the formula (4) as the tertiary amino group-containing polyol (a1-1) include 3-(diethylamine)-1,2-propanediol.

The tertiary amino group-containing polycarboxylic acid is not particularly limited, and examples thereof include a product having a terminal carboxylic acid group obtained by esterification reaction of the tertiary amino group-containing polyol (a1-1) and a polycarboxylic acid, specifically, a product having a terminal carboxylic acid group obtained by dehydration condensation of an N-alkyl dialcohol amine and an aliphatic or aromatic dicarboxylic acid at a functional group molar ratio of 1:2, e.g., a reaction product of N-methyldiethanolamine and succinic acid and a reaction product of N-methyldiethanolamine and terephthalic acid.

The tertiary amino group-containing polyamine is not particularly limited, and examples thereof include a product having a terminal amino group obtained by amidation reaction of the tertiary amino group-containing polycarboxylic acid and a polyamine, a product obtained by producing a product having an isocyanate terminal through urethanization reaction of the tertiary amino group-containing polyol (a1-1) and an organic polyisocyanate and further converting the terminal of the product to an amino group through addition of water, and a product obtained by converting the terminal of the product having the isocyanate terminal to an amino group through addition of a polyamine, specifically, a product having a terminal amino group obtained by performing dehydration condensation of an N-alkyl dialcohol amine and an aliphatic or aromatic dicarboxylic acid at a functional group molar ratio of 1:2 and then dehydration condensation of the resulting product having a terminal carboxylic acid group with a polyamine at a functional group molar ratio of 1:2, a reaction product having a terminal amino group obtained by performing urethanization reaction of an N-alkyl dialcohol amine and an aliphatic, alicyclic, or aromatic diisocyanate at a functional group molar ratio of 1:2 and converting the terminal isocyanate group of the resulting product to amino group with water, and a product having a terminal amino group obtained by dehydration condensation of the product having a terminal isocyanate group with a polyamine at a functional group molar ratio of 1:2, e.g., a product having a terminal amino group obtained by dehydration condensation of N-methyldiethanolamine, succinic acid, and isophoronediamine, a product having a terminal amino group obtained by reaction of N-methyldiethanolamine, isophoronediisocyanate, and water, and a product having a terminal amino group obtained by reaction of N-methyldiethanolamine, isophoronediisocyanate, and isophoronediamine.

The tertiary amino group-containing polyamide is not particularly limited, and examples thereof include a product having a terminal amide group obtained by reaction of the tertiary amino group-containing polycarboxylic acid and ammonia, specifically, a product having a terminal amide group obtained by performing dehydration condensation of an N-alkyl dialcohol amine and an aliphatic or aromatic dicarboxylic acid at a functional group molar ratio of 1:2 and then dehydration condensation of the resulting product having a terminal carboxylic acid group and ammonia at a functional group molar ratio of 1:1, e.g., a reaction product having a terminal amide group obtained by dehydration condensation of the reaction product of N-methyldiethanolamine and succinic acid through addition of ammonia.

Examples of the reaction of a tertiary amino group-containing polycarboxylic acid and ammonia include the following [1] and [2]:
[1] generation of a tertiary amino group-containing polyamide by dehydration of an ammonium salt formed from a tertiary amino group-containing polycarboxylic acid and ammonia, and
[2] generation of a tertiary amino group-containing polyamide and alcohol by ester interchange between a tertiary amino group-containing polycarboxylic acid and ammonia.

The tertiary amino group-containing polyurethane compound is not particularly limited, and examples thereof include a product obtained by urethanization reaction of the tertiary amino group-containing polyol (a1-1) and an organic monoisocyanate at a molar ratio of hydroxyl group and isocyanate group of 1:1, specifically, a product containing a urethane group obtained by reaction of an N-alkyl dialcohol amine and an aliphatic, alicyclic, or aromatic monoisocyanate at a functional group molar ratio of 1:1, e.g., a reaction product of N-methyldiethanolamine and phenylisocyanate.

The tertiary amino group-containing polyurea compound is not particularly limited, and examples thereof include a product containing a urea group obtained by performing urethanization reaction of a tertiary amino group-containing polyol (a1-1) and an organic polyisocyanate and adding ammonia or an organic monoamine to the resulting product having an isocyanate terminal, specifically, a product containing a urea group obtained by performing urethanization reaction of an N-alkyl dialcohol amine and an aliphatic, alicyclic, or aromatic diisocyanate at a functional group molar ratio of 1:2 and reacting ammonia or monoamine to the resulting product having a terminal isocyanate group at a functional group molar ratio of 1:1, e.g., a product obtained by reacting piperidine with the product having a terminal isocyanate group obtained by reaction of N-methyldiethanolamine and isophoronediisocyanate.

Examples of the quaternizing agent (a1-2) include a halogenated alkyl compound, a dialkyl sulfate compound, and a trialkyl phosphate compound, specifically, ethyl bromide, ethyl iodide, dimethyl sulfate, diethyl sulfate, dipropyl sulfate, dibutyl sulfate, and trimethyl phosphate. Among them, from the viewpoint of reaction speed, dimethyl sulfate or diethyl sulfate may be used.

The quaternary ammonium compound (a1) in the present embodiment is a compound represented by the following formula (1) and/or a compound represented by the following formula (2):

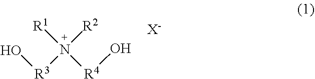

(in formula (1), R¹ and R² are each independently an alkyl group having 1 to 24 carbon atoms, R³ and R⁴ are each independently an alkylene group having 1 to 20 carbon atoms or an oxyalkylene group having 2 to 20 carbon atoms, and X⁻ is an anion),

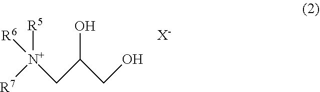

(in formula (2), R⁵ to R⁷ are each independently an alkyl group having 1 to 4 carbon atoms, and X⁻ is an anion).

The quaternary ammonium compound (a1) in the present embodiment is a product obtained by reaction of a compound represented by the formula (1) and/or a tertiary amino group-containing polyol (a1-1) represented by the formula (2) and a quaternizing agent (a1-2) at a compound molecular ratio of 1:1.

Specific examples of the quaternary ammonium compound (a1) represented by the formula (1) include a reaction product of N-methyldiethanolamine and any of ethyl bromide, ethyl iodide, dimethyl sulfate, diethyl sulfate, dipropyl sulfate, dibutyl sulfate, and trimethyl phosphate, a reaction product of N-ethyldiethanolamine and any of ethyl bromide, ethyl iodide, dimethyl sulfate, diethyl sulfate, dipropyl sulfate, dibutyl sulfate, and trimethyl phosphate, a reaction product of N-butyldiethanolamine and any of ethyl bromide, ethyl iodide, dimethyl sulfate, diethyl sulfate, dipropyl sulfate, dibutyl sulfate, and trimethyl phosphate, a reaction product of N-tert-butyldiethanolamine and any of ethyl bromide, ethyl iodide, dimethyl sulfate, diethyl sulfate, dipropyl sulfate, dibutyl sulfate, and trimethyl phosphate, a reaction product of N-lauryldiethanolamine and any of ethyl bromide, ethyl iodide, dimethyl sulfate, diethyl sulfate, dipropyl sulfate, dibutyl sulfate, and trimethyl phosphate, a reaction product of N-stearyldiethanolamine and any of ethyl bromide, ethyl iodide, dimethyl sulfate, diethyl sulfate, dipropyl sulfate, dibutyl sulfate, and trimethyl phosphate, and a reaction product of poly (n=1 to 10) oxyethylene oleylamine and any of ethyl bromide, ethyl iodide, dimethyl sulfate, diethyl sulfate, dipropyl sulfate, dibutyl sulfate, and trimethyl phosphate.

Among them, from the viewpoint of the amount of nitrogen atoms with respect to the weight of the quaternary ammonium compound (a1) (viewpoint of hydrophilicity), the quaternary ammonium compound (a1) may be a reaction product of N-methyldiethanolamine, N-ethyldiethanolamine, N-butyldiethanolamine, N-tert-butyldiethanolamine, N-lauryldiethanolamine, N-stearyldiethanolamine, or poly (n=1 to 10) oxyethylene oleylamine and dimethyl sulfate or diethyl sulfate, a reaction product of N-methyldiethanolamine or N-ethyldiethanolamine and dimethyl sulfate or diethyl sulfate, or a reaction product of N-methyldiethanolamine and dimethyl sulfate.

Specific examples of the quaternary ammonium compound (a1) represented by the formula (2) include a reaction product of 3-(diethylamine)-1,2-propanediol and any of ethyl bromide, ethyl iodide, dimethyl sulfate, diethyl sulfate, dipropyl sulfate, dibutyl sulfate, and trimethyl phosphate. Among them, from the viewpoint of the amount of nitrogen atoms with respect to the weight of the quaternary ammonium compound (a1) (viewpoint of hydrophilicity), the quaternary ammonium compound (a1) may be a reaction product of 3-(diethylamine)-1,2-propanediol and dimethyl sulfate or diethyl sulfate.

The weight rate of the quaternary ammonium compound (a1) in the polyurethane resin according to the present embodiment is 12 wt % or more based on the total weight of the active hydrogen atom-containing component (A) and the organic polyisocyanate component (B) and may be 12 to 60 wt %, 12 to 50 wt %, or 12 to 42 wt %. When the weight rate of the quaternary ammonium compound (a1) is less than 12 wt %, the pigment aqueous dispersion particles become coarse to deteriorate the initial dispersibility.

The active hydrogen atom-containing component (A) may contain a polyol other than the quaternary ammonium compound (a1). Examples of the polyol other than the quaternary ammonium compound (a1) include a polycarbonate polyol, a polyester polyol, a polyether polyol, and a low-molecular-weight polyol. The polyol other than the quaternary ammonium compound (a1) may include at least one of the polycarbonate polyol, polyester polyol, and polyether polyol and may be a polycarbonate polyol. Furthermore, the polycarbonate polyol may be a crystalline polycarbonate polyol.

Examples of the polycarbonate diol include polycarbonate diols manufactured by condensation of a low molecular weight dihydric alcohol having a number-average molecular weight (Mn) of less than 300 and a low molecular carbonate compound (e.g., dialkyl carbonate having 1 to 10 carbon atoms in the alkyl group, alkylene carbonate having 2 to 6 carbon atoms in the alkylene group, and diaryl carbonate having 6 to 9 carbon atoms in the aryl group) while performing dealcoholization reaction. The low molecular weight dihydric alcohols and the alkylene carbonates may be respectively used in combination of two or more. The low molecular weight dihydric alcohol may contain a tri- or higher hydric alcohol.

Specific examples of the polycarbonate diol include aliphatic polycarbonates, such as polyhexamethylene carbonate diol, polydecamethylene carbonate diol, polypentamethylene carbonate diol, 3-methyl-5-pentane-carbonate diol, polytetramethylene carbonate diol, and poly(tetramethylene/hexamethylene) carbonate diol (e.g., diol obtained by condensation of 1,4-butane diol and 1,6-hexane diol with dialkyl carbonate while performing dealcoholization reaction); alicyclic polycarbonate diols, such as polycyclohexamethylene carbonate diol and polynorbornene carbonate diol; and aromatic polycarbonates, such as poly 1,4-xylylene carbonate diol, bisphenol A polycarbonate diol, and bisphenol F polycarbonate diol.

Examples of commercial products of the polycarbonate diol include ETERNACOLL UH-200 (polyhexamethylene carbonate diol of Mn=2,000, manufactured by UBE Corporation), ETERNACOLL UH-100 (polyhexamethylene carbonate diol of Mn=1,000, manufactured by UBE Corporation), ETERNACOLL UC-100 (polycyclohexamethylene carbonate diol of Mn=1,000, manufactured by UBE Corporation], BENEBiOL NL2010DB (polydecamethylene carbonate diol of Mn=2,000, manufactured by Mitsubishi Chemical Corporation), DURANOL T5651 (polypentamethylene-hexamethylene carbonate diol of Mn=1,000, manufactured by Asahi Kasei Corporation), and DURANOL G4672 (polytetramethylene-hexamethylene carbonate diol of Mn=1,000, manufactured by Asahi Kasei Corporation).

In one aspect, the polycarbonate diol according to the present embodiment may be a crystalline polycarbonate polyol.

In the present embodiment, crystallizability means that when the transition temperature of a sample is measured using a differential scanning calorimeter (DSC) according to the method described in JIS K7121, there is a peak top temperature of the endothermic peak. The conditions for measuring the peak top temperature of an endothermic peak will now be described. The measurement is performed using a differential scanning calorimeter (e.g., manufactured by TA Instruments, Q2000). A sample is heated from 20° C. to 150° C. at a condition of 10° C./min in the first temperature rising, then cooled from 150° C. to 0° C. at a condition of 10° C./min, and then heated from 0° C. to 150° C. at a condition of 10° C./min in the second temperature rising, and the temperature showing the top of an endothermal peak in the process of the second temperature rising is defined as the peak top temperature of the endothermic peak.

When the polyurethane resin includes a polyol component containing a crystalline polycarbonate polyol in the constituent monomer (constituent unit), the mechanical strength can be improved to improve the scuffing resistance.

Examples of the crystalline polycarbonate polyol include polycarbonate diols manufactured by condensation of a saturated low molecular weight aliphatic or alicyclic dihydric alcohol and a low molecular carbonate compound (e.g., dialkyl carbonate having 1 to 10 carbon atoms in the alkyl group, alkylene carbonate having 2 to 6 carbon atoms in the alkylene group, and diaryl carbonate having 6 to 9 carbon atoms in the aryl group) while performing dealcoholization reaction. The low molecular weight dihydric alcohols and the alkylene carbonates may be respectively used in combination of two or more, and from the viewpoint of crystallizability, the content of one alcohol raw material may be 70 to 100 wt % or 100 wt %.

Specific examples of the crystalline polycarbonate diol include polyhexamethylene carbonate diol, polydecamethylene carbonate diol, and polycyclohexamethylene carbonate diol.

Examples of the polyester polyol include a condensed polyester diol, a polylactone diol, and a castor oil based diol.

The condensed polyester diol is a polyester diol of a dihydric alcohol having a number-average molecular weight (Mn) of less than 300 and a dicarboxylic acid having 2 to 10 carbon atoms or an ester forming derivative thereof.

As the low molecular weight dihydric alcohol, an aliphatic dihydric alcohol having an Mn of less than 300 and a low molar adduct of alkylene oxide (hereinafter, may be abbreviated to AO) of a dihydric phenol having an Mn of less than 300 can be used. Examples of the AO include ethylene oxide (hereinafter, may be abbreviated to EO), a propylene oxide (hereinafter, may be abbreviated to PO), and 1,2-, 1,3-, 2,3-, or 1,4-butylene oxide.

The low molecular weight dihydric alcohol that can be used for the condensed polyester polyol may be ethylene glycol, propylene glycol, 1,4-butanediol, neopentyl glycol, 1,6-hexane glycol, 1,9-nonanediol, 1,10-decanediol, an EO or PO low molar adduct of bisphenol A, or a combination thereof. The constituent component of the condensed polyester diol may include a tri- or higher hydric alcohol, a tri- or higher hydric carboxylic acid, or an ester forming derivative thereof.

Examples of the dicarboxylic acid having 2 to 10 carbon atoms or its ester forming derivative that can be used for the condensed polyester diol include aliphatic dicarboxylic acids (such as succinic acid, adipic acid, azelaic acid, sebacic acid, dodecanedioic acid, fumaric acid, and maleic acid), alicyclic dicarboxylic acids (such as dimer acid), aromatic dicarboxylic acids (such as terephthalic acid, isophthalic acid, and phthalic acid), anhydrides thereof (such as succinic anhydride, maleic anhydride, and phthalic anhydride), acid halides thereof (such as adipic acid dichloride), low molecular weight alkyl esters thereof (such as dimethyl succinate and dimethyl phthalate), and combinations thereof. Examples of the tri- or higher polycarboxylic acid include trimellitic acid and pyromellitic acid.

Specific examples of the condensed polyester polyol include polyethylene adipate diol, polybutylene adipate diol, polyhexamethylene adipate diol, polyhexamethylene isophthalate diol, polyhexamethylene terephthalate diol, polyneopentyl adipate diol, polyethylene propylene adipate diol, polyethylene butylene adipate diol, polybutylene hexamethylene adipate diol, polydiethylene adipate diol, poly(polytetramethylene ether) adipate diol, poly(3-methylpentylene adipate) diol, polyethylene azelate diol, polyethylene sebacate diol, polybutylene azelate diol, polybutylene sebacate diol, and polyneopentyl terephthalate diol.

Examples of commercial products of the condensed polyester polyol include SANESTER 2610 (polyethylene adipate diol of Mn=1,000, manufactured by Sanyo Chemical Industries, Ltd.), SANESTER 4620 (polytetramethylene adipate diol of Mn=2,000), SANESTER 2620 (polyethylene adipate diol of Mn=2,000, manufactured by Sanyo Chemical Industries, Ltd.), Kuraray Polyol P-2010 (poly-3-methyl-1,5-pentane adipate diol of Mn=2,000), Kuraray Polyol P-3010 (poly-3-methyl-1,5-pentane adipate diol of Mn=3,000), Kuraray Polyol P-6010 (poly-3-methyl-1,5-pentane adipate diol of Mn=6,000), Kuraray Polyol P-2020 (poly-3-methyl-1,5-pentane terephthalate diol of Mn=2,000), and P-2030 (poly-3-methyl-1,5-pentane isophthalate diol of Mn=2,000).

The polylactone diol is a polyadduct of a lactone to the low molecular weight dihydric alcohol, and examples the lactone include lactones having 4 to 12 carbon atoms (e.g., γ-butyrolactone, γ-valerolactone, and ε-caprolactone).

Specific examples of polylactone polyol include polycaprolactone diol, polyvalerolactone diol, and polycaprolactone triol.

A castor oil-based polyol includes castor oil and a polyol or modified castor oil modified with AO. The modified castor oil can be manufactured by ester interchange between castor oil and a polyol and/or AO addition. Examples of the castor oil-based polyol include castor oil, trimethylolpropane-modified castor oil, pentaerythritol-modified castor oil, and EO (4 to 30 moles) adduct of castor oil.

Examples of the polyether polyol include an aliphatic polyether diol and an aromatic ring-containing polyether diol.

Examples of the aliphatic polyether diol include polyoxyethylene polyols (such as polyethylene glycol (hereinafter, abbreviated to PEG)), polyoxypropylene polyol (such as polypropylene glycol), polyoxyethylene/propylene polyol and polytetramethylene ether glycol.

Examples of commercial products of the aliphatic polyether diol include PTMG 1000 (polytetramethylene ether glycol of Mn=1,000, manufactured by Mitsubishi Chemical Corporation), PTMG 2000 (polytetramethylene ether glycol of Mn=2,000, manufactured by Mitsubishi Chemical Corporation), PTMG 3000 (polytetramethylene ether glycol of Mn=3,000, manufactured by Mitsubishi Chemical Corporation), PTGL 3000 (modified PTMG of Mn=3,000, manufactured by Hodogaya Chemical Co., Ltd.), and SANNIX Diol GP-3000 (polypropylene ether triol of Mn=3,000, manufactured by Sanyo Chemical Industries, Ltd.).

Examples of the aromatic polyether diol include polyols having a bisphenol skeleton and EO or PO adducts of resorcin, for example, EO adducts of bisphenol A (such as 2-mole EO adduct of bisphenol A, 4-mole EO adduct of bisphenol A, 6-mole EO adduct of bisphenol A, 8-mole EO adduct of bisphenol A, 10-mole EO adduct of bisphenol A, and 20-mole EO adduct of bisphenol A) and PO adducts of bisphenol A (such as 2-mole PO adduct of bisphenol A, 3-mole PO adduct of bisphenol A, and 5-mole PO adduct of bisphenol A).

Examples of the low molecular weight polyol include the above-mentioned aliphatic diols having 2 to 20 carbon atoms, and the low molecular weight polyol may be a diol having a branched structure with 4 to 10 carbon atoms; 3-methyl-1,5-pentane diol or neopentyl glycol; or 3-methyl-1,5-pentane diol. When a low molecular weight polyol having a branched structure is used, since the cohesive force between hard segments (urethane bind sites) in the polyurethane resin decreases, the solvent solubility and the flexibility of a coating film are improved, and the initial dispersibility (in particular, a reduction in particle diameter) is excellent. When the active hydrogen atom-containing component (A) contains a low molecular weight polyol, the amount of the low molecular weight polyol may be 0.1 to 4.5 wt % or 0.3 to 2 wt % based on the total weight of the active hydrogen atom-containing component (A) and the organic polyisocyanate component (B).

Examples of the organic polyisocyanate component (B) used in the polyurethane resin include an aliphatic polyisocyanate having 2 or more isocyanate groups and having 2 to 18 carbon atoms, an alicyclic polyisocyanate having 4 to 15 carbon atoms, an aromatic polyisocyanate having 6 to 20 carbon atoms (excluding the carbon in the isocyanate group, the same applies hereinafter), an aromatic-aliphatic polyisocyanate having 8 to 15 carbon atoms, and derivatives of these polyisocyanates (e.g., isocyanurate products). The polyisocyanate components may be used alone or in combination of two or more.

Examples of the aliphatic polyisocyanate having 2 to 18 carbon atoms include ethylene diisocyanate, tetramethylene diisocyanate, hexamethylene diisocyanate (HDI), dodecamethylene diisocyanate, 2,2,4-trimethylhexamethylene diisocyanate, lysine diisocyanate, and 2-isocyanatoethyl-2,6-diisocyanatohexanoate.

Examples of the alicyclic polyisocyanate having 4 to 15 carbon atoms include isophorone diisocyanate (IPDI), dicyclohexylmethane-4,4-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- or 2,6-norbornane diisocyanate.

Examples of the aromatic polyisocyanate having 6 to 20 carbon atoms include 1,3- or 1,4-phenylene diisocyanate, 2,4- or 2,6-trilene diisocyanate (TDI), 4,4′- or 2,4′-diphenylmethane diisocyanate (MDI), 1,5-naphthylene diisocyanate, 4,4′,4″-triphenylmethane triisocyanate, m- or p-isocyanatophenyl sulfonyl isocyanate, and crude MDI.

Examples of the aromatic-aliphatic polyisocyanate having 8 to 15 carbon atoms include m- or p-xylylene diisocyanate (XDI) and α,α,α′,α′-tetramethylxylylene diisocyanate (TMXDI).

From the viewpoint of the initial dispersibility and mechanical strength of the pigment aqueous dispersion, the organic polyisocyanate component (B) may be an aromatic polyisocyanate having 6 to 20 carbon atoms or an alicyclic polyisocyanate having 4 to 15 carbon atoms or may be TDI, IPDI, or hydrogenated MDI.

The equivalent ratio of the isocyanate group included in the organic polyisocyanate component (B) to the hydroxyl group included in the active hydrogen atom-containing component (A), (NCO/OH), may be 1.2 to 1.8 or 1.3 to 1.6 from the viewpoint of uniformization of the composition distribution of the polyurethane resin and the mechanical strength.

The polyurethane resin includes the above-described active hydrogen atom-containing component (A) and organic polyisocyanate component (B) as essential constituent monomers (constituent units) and may include a compound other than the active hydrogen atom-containing component (A) and the organic polyisocyanate component (B) as a constituent monomer. Examples of the constituent monomer other than the active hydrogen atom-containing component (A) and the organic polyisocyanate component (B) include a chain extender and a reaction terminator. These constituent monomers may be used alone or in combination of two or more. In one aspect, the polyurethane resin may be a reaction product of a chain extender and a urethane prepolymer having an isocyanate group at a terminal obtained by reaction of the active hydrogen atom-containing component (A) and the organic polyisocyanate component (B).

In the polyurethane resin, a chain extender may be used. Examples of the chain extender include water, diamines having 2 to 10 carbon atoms (e.g., ethylene diamine, propylene diamine, hexamethylene diamine, isophorone diamine, toluene diamine, and piperazine), polyalkylene polyamines having 2 to 10 carbon atoms (e.g., diethylene triamine, triethylene tetramine, and tetraethylene pentamine), hydrazine or a derivative thereof (dibasic acid dihydrazide, e.g., adipic acid dihydrazide), polyepoxy compounds having 2 to 30 carbon atoms (e.g., 1,6-hexanediol diglycidyl ether and trimethylolpropane polyglycidyl ether), and aminoalcohols having 2 to 10 carbon atoms (e.g., ethanolamine, diethanolamine, 2-amino-2-methylpropanol, and triethanolamine). The chain extender may be a diamine having 2 to 10 carbon atoms, a secondary diamine, or isophoronediamine. When the polyurethane resin includes the compound above as a constituent monomer, the cohesive force of the urethane group part is improved, and the degree of swelling in water is decreased to express excellent wet friction fastness. When a diamine is used, the generation of carbon dioxide gas is suppressed by an extension reaction by the amine, and the generation amount of a carbonate amine salt is decreased to improve the preservation stability.

The amount of the chain extender used may be such that the equivalent ratio of the active hydrogen-containing group of the chain extender to the isocyanate group at the urethane prepolymer terminal may be within a range of 0.2 to 2 or a range of 0.5 to 1.5.

In the polyurethane resin, a reaction terminator can be used as needed. Examples of the reaction terminator include monoalcohols having 1 to 8 carbon atoms (e.g., methanol, ethanol, isopropanol, cellosolves, and carbitols), monoamines having 1 to 10 carbon atoms (e.g., mono or dialkylamines, such as monomethylamine, monoethylamine, monobutylamine, dibutylamine, and monooctylamine; and mono or dialkanolamines, such as monoethanolamine, diethanolamine, and diisopropanolamine).

Examples of the method for manufacturing a polyurethane resin according to the present embodiment include the following methods [1] to [4]:
[1] A method of reacting a polyol component, a tertiary amino group-containing polyol (a1-1), and a polyisocyanate component in the presence or absence of a hydrophilic solvent in one step or in multiple steps to manufacture a polyurethane resin having an isocyanate group at a terminal and then quaternizing the resin with a quaternizing agent (a1-2);
[2] A method of reacting a tertiary amino group-containing polyol (a1-1) and a quaternizing agent (a1-2) in the presence or absence of a hydrophilic solvent in one step or in multiple steps to manufacture a quaternary ammonium compound (a1) and then reacting a polyol component and a polyisocyanate component in one step or in multiple steps to manufacture a polyurethane resin;
[3] A method of reacting a polyol component, a tertiary amino group-containing polyol (a1-1), and a polyisocyanate component in the presence or absence of a hydrophilic solvent in one step or in multiple steps to manufacture a polyurethane resin having an isocyanate group at a terminal, then reacting a chain extender and/or a reaction terminator and the isocyanate group in the polyurethane resin, and ultimately performing quaternization with a quaternizing agent (a1-2); and
[4] A method of reacting a polyol component, a tertiary amino group-containing polyol (a1-1), and a polyisocyanate component in the presence or absence of a hydrophilic solvent in one step or in multiple steps to manufacture a polyurethane resin having an isocyanate group at a terminal, performing quaternization with a quaternizing agent (a1-2) and then dispersing in an aqueous medium, reacting a chain extender and/or a reaction terminator and the isocyanate group in the polyurethane resin, and then distilling away the hydrophilic solvent as needed.

The polyurethane resins manufactured by the method [1] to [4] above can be used for manufacturing a pigment aqueous dispersion. Among these methods, the methods of [1] to [3] may be used from the viewpoint of the preservation stability of the pigment aqueous dispersion.

Examples of the hydrophilic solvent to be used for manufacturing the polyurethane resin by [3] above include those substantially unreactive with an NCO group (ketones, such as acetone and ethyl methyl ketone; esters; ethers; amides; and alcohols). Among them, tetrahydrofuran may be used. The aqueous medium may be water only, or a liquid mixture of water and a hydrophilic solvent can also be used. The weight ratio of the hydrophilic solvent to water (hydrophilic solvent/water) may be 0/100 to 50/50 or 35/65 to 45/55. When the hydrophilic solvent is used, the solvent may be distilled away after manufacturing the polyurethane resin as needed.

The polyurethane resin may be formed by a reaction at 20° C. to 150° C. or 60° C. to 110° C., and the reaction time may be 2 to 20 hours.

The polyurethane resin can be formed and synthesized in the presence or absence of an organic solvent substantially unreactive with an NCO group. The polyurethane resin having an isocyanate group at a terminal usually contains 0.5% to 10% of a free NCO group. Examples of the organic solvent substantially unreactive with an NCO group include the hydrophilic solvents mentioned above, and the solvent may be tetrahydrofuran.

In the manufacturing of the polyurethane resin, in order to facilitate the reaction, a catalyst that is used in usual urethane reactions may be used as needed. Examples of the catalyst include amine catalysts, such as triethylamine, N-ethylmorpholine, triethylene diamine, and cycloamidines described in U.S. Pat. No. 4,524,104 (such as 1,8-diaza-bicyclo(5,4,0)undecene-7 (manufactured by San-Apro Ltd., DBU)); tin catalysts, such as dibutyltin dilaurate, dioctyltin dilaurate, and tin octylate; and titanium catalysts, such as tetrabutyl titanate.

The polyurethane resin isocyanate group content can be measured by the method specified in JIS K1603-1. In examples of the present embodiment, the isocyanate group content (NCO wt %) of the solvent solution was used.

The content rate of the urea group based on the weight of the polyurethane resin may be 0.01 to 0.2 wt % or 0.05 to 0.1 wt %. When the content rate of the urea group based on the weight of the polyurethane resin (U) is 0.01 to 0.2 wt % (may be 0.05 to 0.1 wt %), the urea group content in the polyurethane resin is appropriate, and the mechanical strength and the viscosity of the water dispersion can be simultaneously achieved.

Examples of the pigment in the present embodiment include known organic and inorganic pigments (e.g., white pigment, black pigment, gray pigment, red pigment, brown pigment, yellow pigment, green pigment, blue pigment, violet pigment, and metallic pigment, natural organic pigment, synthetic organic pigment, nitroso pigment, nitro pigment, pigment color type azo pigment, azo chelate made from water-soluble dye, azo chelate made from slightly soluble dye, lake made from basic dye, lake made from acid dye, xanthan lake, anthraquinone lake, pigment form of vat dye, and phthalocyanine pigment, and organic pigments such as daylight and fluorescence).

Specific examples of the organic and inorganic pigments are shown below.

Examples of the white pigment include inorganic pigments, such as titanium oxide, zinc white, zinc sulfide, antimony oxide, and zirconium oxide. In addition to inorganic pigments, hollow resin microparticles and polymer microparticles can also be used.

The pigment may have an average particle diameter of 200 to 300 nm. When the average particle diameter of the pigment is less than 200 nm, the hiding power tends to be insufficient, and when higher than 300 nm, the discharge stability tends to be insufficient.

In particular, from the viewpoint of hiding power, titanium oxide may be used. The average particle diameter of titanium oxide may also be 200 to 300 nm.

The pigment for magenta is not particularly limited, and examples thereof include C.I. Pigment 2, C.I. Pigment 3, C.I. Pigment 5, C.I. Pigment 6, C.I. Pigment 7, C.I. Pigment 15, C.I. Pigment 16, C.I. Pigment 48:1, C.I. Pigment 53:1, C.I. Pigment 57:1, C.I. Pigment 122, C.I. Pigment 123, C.I. Pigment 139, C.I. Pigment 144, C.I. Pigment 149, C.I. Pigment 166, C.I. Pigment 177, C.I. Pigment 178, and C.I. Pigment 222.

The pigment for yellow is not particularly limited, and examples thereof include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 155, and Pigment Yellow 180.

The pigment for cyan is not particularly limited, and examples thereof include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, and C.I. Pigment Green 7.

Examples of the pigment for black include carbon black (C.I. Pigment Black 7) such as furnace black, lamp black, acetylene black, and channel black, metals such as copper and iron (C.I. Pigment Black 11), metal compounds such as titanium oxide, and organic pigments such as aniline black (C.I. Pigment Black 1).

The total weight of the pigment and the polyurethane resin in the pigment aqueous dispersion according to the present embodiment may be 10 to 40 wt % or 20 to 30 wt % from the viewpoint of preservation stability.

In the pigment aqueous dispersion in the present embodiment, the ratio of the pigment and the polyurethane resin, pigment:polyurethane resin, may be 60:40 to 40:60 from the viewpoint of initial dispersibility and rubbing fastness.

In the pigment aqueous dispersion, generally, particles consisting of a pigment and a polyurethane resin are dispersed in water. The particle diameter of the particles in the pigment aqueous dispersion may be, from the viewpoint of storage stability and viscosity, 100 to 200 nm or 120 to 180 nm in color pigments and 200 to 400 nm or 220 to 300 nm in white pigments. In the present embodiment, the particle diameter means the cumulant average diameter. The particle diameter can be determined by measuring with a light scattering particle size distribution measuring apparatus (e.g., manufactured by Otsuka Electronics Co., Ltd., “DLS-8000”).

As the method for manufacturing a pigment aqueous dispersion, all known methods can be used. Examples of the known method include a surface polymerization method by adsorbing and polymerizing a monomer on the pigment dispersion surface, a surface deposition method by dispersing a pigment in a resin solution and adding a poor solvent for the resin thereto to deposit the resin on the pigment surface, a kneading and refining method by melting and kneading a pigment and a resin to form a master batch and performing refining by a wet process, a method of allowing a resin solution to permeate into pigment aggregate using a high-pressure fluid and simultaneously achieving miniaturization and coating by expansion energy when released to the atmospheric pressure, a method of refining a pigment and a resin aqueous dispersion by a wet process and dispersing them by a mechanical energy, and a phase inversion emulsification method by refining a resin solution with self-dispersibility in water and a pigment by a wet process and charging water into the solvent phase to obtain a pigment aqueous dispersion.

Among them, the method suitable for manufacturing the pigment aqueous dispersion according to the present embodiment is the method of refining a pigment and a resin aqueous dispersion by a wet process and dispersing them by a mechanical energy or the phase inversion emulsification method from the viewpoint of initial dispersibility and preservation stability.

In the method of dispersing a pigment and a resin aqueous dispersion by a mechanical energy and the phase inversion emulsification method, since the pigment particle surface is adsorbed to or coated with a self-dispersible polyurethane resin forming a coating film, the pigment as a color material can be fixed on a base material without adding another binder resin to the ink, and the methods may be used from the viewpoint of fastness.

Since the phase inversion emulsification method forms a structure of covering the pigment surface with a resin, the frequency of exposure of the pigment surface to the ink is low, there is no composition distribution as dispersed particles, and a structural change is unlikely to occur. Accordingly, the method may be used from the viewpoint of preservation stability.

### Manufacturing Method of Pigment Aqueous Dispersion

The pigment aqueous dispersion according to the present embodiment is manufactured by, for example, the following methods [A] to [C]:
[A] A method of adding a pigment to a solution of a polyurethane resin having an isocyanate group terminal described in the method of [1] above, performing mixing and homogenization, then refining the solvent solution containing the pigment by mechanical crushing, and after the refining, converting the carboxyl group into a salt by a neutralizing agent and emulsifying and dispersing it in an aqueous medium, reacting a chain extender and/or a reaction terminator with the isocyanate group in the polyurethane resin, and then distilling away the hydrophilic solvent as needed;
[B] A method of adding a pigment to a polyurethane resin solution described in the method of [2] above, performing mixing and homogenization, then refining the solvent solution containing the pigment by mechanical crushing, and after the refining, converting the carboxyl group into a salt by a neutralizing agent and emulsifying and dispersing it in an aqueous medium, and distilling away the hydrophilic solvent as needed; and
[C] A method of adding a pigment to a polyurethane resin dispersion liquid described in the method of [3] above, performing mixing and homogenization, and then refining the aqueous dispersion liquid containing the pigment by mechanical crushing.

Incidentally, in the manufacturing methods of [A] to [C] above, as the apparatus that is used for mixing and homogenization, the apparatus for synthesizing the polyurethane resin can be used without change, and examples of the disperser used for refining include a paint shaker, a ball mill, a sand mill, and a nano mill, and specifically, DYNO-MILL (manufactured by Shinmaru Enterprises Corporation) and TSU-6U (manufactured by AIMEX Co., Ltd.).

In the methods [A] and [B] for manufacturing a pigment aqueous dispersion, the apparatus for emulsifying and dispersing in an aqueous medium is not particularly limited, and examples thereof include emulsifiers of the following systems:
1) anchor agitation system, 2) rotor-stator system (e.g., “Ebara Milder” (manufactured by Ebara Corporation)), 3) in-line system (e.g., in-line flow mixer), 4) static tube mixing system (e.g., static mixer), 5) vibration system (e.g., “VIBRO MIXER” (manufactured by Reika Kogyo K.K.)), 6) ultrasonic impact system (e.g., ultrasonic homogenizer), 7) high-pressure impact system (e.g., Gaulin Homogenizer (Gaulin)), 8) emulsification system (e.g., membrane emulsification module), and 9) centrifugal thin-film contact system (e.g., FILMIX). Among them, the apparatus may be an anchor type agitation system.

The pigment aqueous dispersion can contain additives, such as a surfactant, a crosslinking agent, a weatherproof stabilizer, and a smoothing agent, as needed. The additives may be used alone or in combination of two or more. The amount of the additive to be used may be 15 wt % or less, 10 wt % or less, or 5 wt % or less based on the total weight of the pigment and the polyurethane resin.

In one aspect, the pigment aqueous dispersion of the present embodiment may contain a surfactant. When the pigment aqueous dispersion of the present embodiment contains a surfactant, the preservation stability and the dry rubbing fastness of the pigment aqueous dispersion after heating are further improved. The surfactant may be added during the manufacturing of the pigment aqueous dispersion.

When a surfactant is used during the manufacturing of the pigment aqueous dispersion, the surfactant may be added at any time during the manufacturing. In one aspect, from the viewpoint of the dispersibility of the pigment and the stability of the aqueous dispersion, the surfactant may be added before or during dispersing the pigment in the polyurethane resin. The surfactant may be added to one of or both the solvent solution of the polyurethane resin and the aqueous medium. When the surfactant is reactive with the urethane prepolymer, the supernatant may be added to the aqueous medium. The amount of the surfactant to be added may be 0.2 to 10 wt % or 0.3 to 6 wt % based on the weight of the pigment.

Examples of the surfactant include nonionic surfactants, anionic surfactants, cationic surfactants, amphoteric surfactants, and other emulsifying dispersants. The surfactants may be used alone or in combination of two or more. Among them, the surfactant may be a nonionic surfactant.

Examples of the nonionic surfactant include aliphatic alcohol (having 8 to 24 carbon atoms) AO (having 2 to 8 carbon atoms) adducts (degree of polymerization=1 to 100), polyhydric alcohol (having 3 to 18 carbon atoms) AO (having 2 to 8 carbon atoms) adducts (degree of polymerization=1 to 100), (poly)oxyalkylene (having 2 to 8 carbon atoms, degree of polymerization=1 to 100) higher fatty acid (having 8 to 24 carbon atoms) esters (e.g., mono- or di-fatty acid polyethylene glycol esters, such as monooleic acid polyethylene glycol ester (HLB=6 to 17), monostearic acid polyethylene glycol ester (HLB=8 to 15), and distearic acid polyethylene glycol ester (HLB=8 to 14)), polyhydric (dihydric to decahydric or higher) alcohol fatty acid (having 8 to 24 carbon atoms) esters (such as monostearic acid glycerin, monostearic acid ethylene glycol, and fatty acid sorbitan ester (monooleic acid sorbitan and monolauric acid sorbitan)), (poly)oxyalkylene (having 2 to 8 carbon atoms, degree of polymerization=1 to 100) polyhydric (dihydric to decahydric or higher) alcohol higher fatty acid (having 8 to 24 carbon atoms) esters (such as monolauric acid polyoxyethylene sorbitan (HLB=10 to 16) and polyoxyethylene dioleic acid methyl glucoside (HLB=17)), fatty acid alkanolamide (e.g., 1:1 type coconut oil fatty acid diethanolamide and 1:1 type lauric acid diethanolamide), (poly)oxyalkylene (having 2 to 8 carbon atoms, degree of polymerization=1 to 100) alkyl (having 1 to 22 carbon atoms) phenyl ether, (poly)oxyalkylene (having 2 to 8 carbon atoms, degree of polymerization=1 to 100) alkyl (having 8 to 24 carbon atoms) aminoether, and alkyl (having 8 to 24 carbon atoms) dialkyl (having 1 to 6 carbon atoms) amine oxide (such as lauryl dimethylamine oxide).

In particular, the nonionic surfactant may be a mono- or di-fatty acid polyethylene glycol ester, such as aliphatic alcohol (having 8 to 24 carbon atoms) AO (having 2 to 8 carbon atoms) adducts (HLB=5 to 18), polyhydric alcohol (having 3 to 18 carbon atoms) AO (having 2 to 8 carbon atoms) adducts (HLB=11 to 24), monooleic acid sorbitan, monooleic acid polyethylene glycol ester (HLB=6 to 17), monostearic acid polyethylene glycol ester (HLB=8 to 15), and distearic acid polyethylene glycol ester (HLB=8 to 14).

In one aspect, since nonionic surfactant are excellent in dry rubbing fastness and stability under heating, the pigment aqueous dispersion of the present embodiment may contain a nonionic surfactant. The nonionic surfactant may be an aliphatic alcohol (having 8 to 24 carbon atoms) AO (having 2 to 8 carbon atoms) adduct (HLB=5 to 18), a polyhydric alcohol (having 3 to 18 carbon atoms) AO (having 2 to 8 carbon atoms) adduct (HLB=11 to 24), a monooleic acid sorbitan, or a monooleic acid polyethylene glycol ester (HLB=6 to 17).

Examples of the anionic surfactant include ether carboxylic acids having hydrocarbon groups having 8 to 24 carbon atoms or salts thereof (such as sodium lauryl ether acetate and (poly)oxyethylene (addition number of moles=1 to 100) lauryl ether sodium acetate); sulfates or ether sulfates having hydrocarbon groups having 8 to 24 carbon atoms or salts thereof (such as sodium lauryl sulfate, (poly)oxyethylene (addition number of moles=1 to 100) sodium lauryl sulfate, (poly)oxyethylene (addition number of moles=1 to 100) triethanolamine lauryl sulfate, and (poly)oxyethylene (addition number of moles=1 to 100) coconut oil fatty acid monoethanolamide sodium sulfate); sulfonates having hydrocarbon groups having 8 to 24 carbon atoms (such as dodecylbenzene sodium sulfonate); sulfosuccinic acid salts having one or two hydrocarbon groups having 8 to 24 carbon atoms; phosphates or ether phosphates having hydrocarbon groups having 8 to 24 carbon atoms or salts thereof (such as sodium lauryl phosphate and (poly)oxyethylene (addition number of moles=1 to 100) sodium lauryl ether phosphate); fatty acid salts having hydrocarbon groups having 8 to 24 carbon atoms (such as sodium laurate and triethanolamine laurate); and acylated amino acid salts having hydrocarbon groups having 8 to 24 carbon atoms (such as coconut oil fatty acid methyl taurine sodium, coconut oil fatty acid sarcosine sodium, coconut oil fatty acid sarcosine triethanolamine, N-coconut oil fatty acid acyl-L-glutamic acid triethanolamine, N-coconut oil fatty acid acyl-L-glutamic acid sodium, and lauroyl methyl-β-alanine sodium).

Examples of the cationic surfactant include quaternary ammonium salt types (such as stearyl trimethylammonium chloride, behenyl trimethylammonium chloride, distearyl dimethylammonium chloride, and ethyl sulfuric acid lanolin fatty acid aminopropylethyl dimethylammonium) and amine salt types (such as stearic acid diethylaminoethylamide lactate, dilaurylamine hydrochloride, and oleylamine lactate).

Examples of the amphoteric surfactant include betaine type amphoteric surfactants (such as coconut oil fatty acid amide propyldimethylaminoacetic acid betaine, lauryldimethylaminoacetic acid betaine, 2-alkyl-N-carboxymethyl-N-hydroxyethylimidazolinium betaine, lauryl hydroxysulfobetaine, and lauroylamidoethylhydroxyethylcarboxymethyl betaine hydroxypropylphosphate sodium) and amino acid type amphoteric surfactants (such as sodium β-laurylaminopropionate).

Examples of the other emulsifying dispersants include polyvinyl alcohol, starch and derivatives thereof, cellulose derivatives such as carboxymethyl cellulose, methyl cellulose, and hydroxyethyl cellulose, carboxyl group-containing (co)polymer such as sodium polyacrylate, and emulsifying dispersants having a urethane group or an ester group described in U.S. Pat. No. 5,906,704 (e.g. product obtained by linking a polylactone polyol and a polyether diol with a polyisocyanate).

When the pigment aqueous dispersion contains a surfactant, the content thereof may be 0.2 to 10 wt % or 0.3 to 6 wt % based on the weight of the polyurethane resin.

The pigment aqueous dispersion of the present embodiment can contain other components appropriately selected as needed. Examples of such components include a dispersant, a penetrant, a pH adjuster, a water-dispersible resin, an antiseptic/antifungal agent, a chelating reagent, a rust inhibitor, an antioxidant, a UV absorber, an oxygen absorber, and a light stabilizer.

It is possible to obtain an aqueous ink jet ink composition having excellent rubbing fastness and color development property to, in particular, non-pretreated fabric by using the obtained pigment aqueous dispersion.

### Aqueous Ink Jet Ink

The ink according to the present embodiment contains the pigment aqueous dispersion according to the present embodiment, water, and a water-soluble organic solvent.

The blending amount of the pigment aqueous dispersion in the ink according to the present embodiment may be 20 to 80 wt %, 30 to 70 wt % or more, or 40 to 60 wt % or more based on the total amount of the ink.

The total weight of the pigment and the polyurethane resin in the ink according to the present embodiment may be 5 to 20 wt % or 10 to 15 wt % based on the total amount of the ink from the viewpoint of preservation stability.

The weight of water in the ink according to the present embodiment may be 50 to 80 wt % or 60 to 75 wt % based on the total amount of the ink.

### Water-Soluble Organic Solvent

The ink according to the present embodiment can contain a water-soluble organic solvent for the purpose of drying preservation of the ink and improvement in the dispersion stability of the pigment. The water-soluble organic solvent is not particularly limited and can be appropriately selected according to the purpose.

The aqueous organic solvent may contain a water-soluble solvent having a normal boiling point (hereinafter, also simply referred to as “bp”) of 180° C. or more (hereinafter, also referred to as “high-boiling point organic solvent”). The moisture retaining property for nozzles are enhanced and also the viscosity of the ink can be optimized by containing a high-boiling point organic solvent.

The “normal boiling point” means the boiling point at an atmospheric pressure of 0.101 MPa. Incidentally, the number of the high-boiling point organic solvents may be one or two or more.

The content of the high-boiling point organic solvent may be 1 to 40 wt %, 5 to 30 wt %, or 10 to 25 wt % based on the total amount of the ink.

The water-soluble organic solvent may be a polyhydric alcohol. The polyhydric alcohol is not particularly limited and can be appropriately selected according to the purpose, and examples of the water-soluble organic solvent include propylene glycol (bp: 188° C.), 1,2,3-butanetriol, 1,2,4-butanetriol (bp: 190° C. to 191° C./24 hPa), glycerin (bp: 290° C.), diglycerin (bp: 270° C./20 hPa), triethylene glycol (bp: 285° C.), tetraethylene glycol (bp: 324° C. to 330° C.), diethylene glycol (bp: 245° C.), and 1,3-butanediol (bp: 203° C. to 204° C.).

The ink can contain another water-soluble organic solvent other than or a solid wetting agent in combination with the water-soluble organic solvent above as needed, instead of some of the water-soluble organic solvent or in addition to the water-soluble organic solvent.

Examples of the water-soluble organic solvent or solid wetting agent include polyhydric alcohols, polyhydric alcohol alkyl ethers, polyhydric alcohol aryl ethers, nitrogen-containing heterocyclic compounds, amides, amines, sulfur-containing compounds, propylene carbonate, ethylene carbonate, and other water-soluble organic solvents.

Examples of the polyhydric alcohol include dipropylene glycol (bp: 232° C.), 1,5-pentanediol (bp 242° C.), 3-methyl-1,3-butanediol (bp: 203° C.), propylene glycol (bp: 187° C.), 2-methyl-2,4-pentanediol (bp: 197° C.), ethylene glycol (bp: 196° C. to 198° C.), tripropylene glycol (bp: 267° C.), hexylene glycol (bp: 197° C.), polyethylene glycol (viscous liquid to solid), polypropylene glycol (bp: 187° C.), 1,6-hexanediol (bp: 253° C. to 260° C.), 1,2-hexanediol (bp: 170° C.), 1,2,6-hexanetriol (bp: 178° C.), trimethylolethane (solid, mp: 199° C. to 201° C.), and trimethylolpropane (solid, mp: 61° C.)

Examples of the polyhydric alcohol alkyl ether include ethylene glycol monoethyl ether (bp: 135° C.), ethylene glycol monobutyl ether (bp: 171° C.), diethylene glycol monomethyl ether (bp: 194° C.), diethylene glycol monobutyl ether (bp: 231° C.), ethylene glycol mono-2-ethylhexyl ether (bp: 229° C.), and propylene glycol monoethyl ether (bp: 132° C.)

The content of the water-soluble organic solvent in the ink is not particularly limited and can be appropriately selected according to the purpose, and may be 1 to 50 wt % or 10 to 30 wt %.

### Surfactant

The ink according to the present embodiment may contain a surfactant. The discharging property of the ink is improved, the wet-spreading property is improved, and the image quality (color development property) becomes good, by containing a surfactant.

Examples of the surfactant include nonionic surfactants, anionic surfactants, cationic surfactants, amphoteric surfactants, and other emulsifying dispersants. The surfactants may be used alone or in combination of two or more. Among them, a nonionic surfactant may be used. Examples of the nonionic surfactant, anionic surfactant, cationic surfactant, and amphoteric surfactant are as mentioned above.

As the surfactant, the ink may contain a nonionic surfactant. When the ink contains a nonionic surfactant, the discharging property and the wet-spreading property are improved, and the image quality (color development property) can become good.

As the surfactant, the ink may contain an alkyl ether type nonionic surfactant having an HLB value of 5 to 12. When the ink contains the surfactant, the discharging property and the wet-spreading property are improved, and the image quality (color development property) can become good. Incidentally, in the present embodiment, the HLB value is a value determined by Griffin method.

The content of the nonionic surfactant may be 0.01 to 10 wt %, 0.05 to 5 wt %, or 0.1 to 3 wt % based on the total amount of the ink.

The ink using the pigment aqueous dispersion of the present embodiment may have a viscosity at 25° C. of 3.0 to 10.0 mPa·s or 3.5 to 6.0 mPa·s. The viscosity can be measured with a cone-plate viscometer under the conditions described in Examples.

The aqueous ink jet ink containing the pigment aqueous dispersion of the present embodiment can be suitably used as an aqueous ink jet ink for, for example, coated printing paper, cardboard, or cotton fabric. The method of printing using the aqueous ink jet ink is not particularly limited, and examples thereof include home printing, commercial printing, sign graphic printing, and pigment textile printing. The method may be pigment textile printing Examples

The present disclosure will now be more specifically described using examples and comparative examples. The present disclosure is by no means limited by the following examples. Hereinafter, “parts” means parts by weight unless otherwise specified.

### Manufacturing Example 1

In a reaction vessel equipped with a cooling tube, a thermometer, a stirrer, and a nitrogen inlet tube, 836.9 parts of diethylene glycol, 327.3 parts of terephthalic acid, 327.3 parts of isophthalic acid, and 2 parts of titanium diisopropoxy bistriethanol aminate as a condensation catalyst were charged and were reacted at 200° C. in a nitrogen gas flow for 3 hours while distilling away the generated water and further reacted under reduced pressure of 0.5 to 2.5 kPa at 200° C. for 6 hours. The reaction product was taken out from the reaction vessel at the time when the acid value (mg KOH/g) reached less than 1 to obtain a polyester diol having a hydroxyl value (mg KOH/g) of 56.1.

In a simple pressurized reactor equipped with a stirrer and a heating device, 45.1 parts of the polyester diol, 3.6 parts of 3-methyl-1,5-pentanediol, 7.5 parts of N-methyldiethanolamine as a polyol component having a tertiary amino group in the side chain, 36.9 parts of dicyclohexylmethane-4,4-diisocyanate (MDI-H) as a polyisocyanate component, and 100 parts of tetrahydrofuran as an organic solvent for reaction were charged and were stirred at 70° C. for 12 hours to perform urethanization reaction, and then 6.9 parts of dimethyl sulfate was charged, followed by reaction at 50° C. for 4 hours to manufacture a solvent solution of polyurethane resin (P-1) having an isocyanate group containing a quaternary ammonium salt.

### Manufacturing Example 2

In a simple pressurized reactor equipped with a stirrer and a heating device, 45.1 parts of a polycarbonate diol (manufactured by UBE Corporation ETERNACOLL UH-200), 3.6 parts of 3-methyl-1,5-pentanediol, 7.5 parts of N-methyldiethanolamine as a polyol component having a tertiary amino group in the side chain, 36.9 parts of dicyclohexylmethane-4,4-diisocyanate (MDI-H) as a polyisocyanate component, and 100 parts of tetrahydrofuran as an organic solvent for reaction were charged and were stirred at 70° C. for 12 hours to perform urethanization reaction, and then 6.9 parts of dimethyl sulfate was charged, followed by reaction at 50° C. for 4 hours to manufacture a solvent solution of polyurethane resin (P-2) having an isocyanate group containing a quaternary ammonium salt.

### Manufacturing Examples 3 to 12

Solvent solutions of polyurethane resins (P-3) to (P-12) were obtained as in manufacturing example 2 except that the raw materials used and the amounts thereof were changed to those shown in Table 1.

### Manufacturing Example 13

Thirty parts of a solvent solution of the polyurethane resin (P-4) obtained in manufacturing example 4 was put in a vessel equipped with a stirrer, and 84.4 parts of water was added thereto while stirring at 200 rpm to disperse the mixture. To the obtained dispersion, 0.64 parts of isophoronediamine (IPDA) as an extender was added to perform extension reaction with stirring for 30 minutes, and the tetrahydrofuran was distilled away under reduced pressure at 60° C. over 2 hours. The solid concentration was adjusted to 16.7 wt % with water to obtain a dispersion liquid of polyurethane resin (P-13).

### Manufacturing Example 14

In a pressure-resistant reactor vessel equipped with a thermometer, a heating cooling device, a stirrer, and a drop cylinder, 57 parts of myristyl alcohol and 0.08 parts of potassium hydroxide were charged. After purging with nitrogen and then sealing, the temperature was raised to 140° C. With stirring, 43 parts of ethylene oxide was dropwise added thereto over 5 hours at 140° C. while adjusting the pressure to 0.5 MPa or less, and maturing was then performed at the same temperature for 3 hours to obtain a 4-mole ethylene oxide adduct of myristyl alcohol (O-1).

### Manufacturing Example 15

In a same reactor vessel as in manufacturing example 14, 36 parts of oleyl alcohol and 0.08 parts of potassium hydroxide were charged. After purging with nitrogen and then sealing, the temperature was raised to 140° C. With stirring, 64 parts of ethylene oxide was dropwise added thereto over 5 hours at 140° C. while adjusting the pressure to 0.5 MPa or less, and maturing was then performed at the same temperature for 3 hours to obtain an 11-mole ethylene oxide adduct of oleyl alcohol (O-2).

### Manufacturing Example 16

In a same reactor vessel as in manufacturing example 14, 15 parts of sorbitol and 0.08 parts of potassium hydroxide were charged. After purging with nitrogen and then sealing, the temperature was raised to 140° C. With stirring, 85 parts of ethylene oxide was dropwise added thereto over 5 hours at 140° C. while adjusting the pressure to 0.5 MPa or less, and maturing was then performed at the same temperature for 3 hours to obtain a 24-mole ethylene oxide adduct of sorbitol (O-3).

### Manufacturing Example 17

In a reaction vessel equipped with a cooling tube, a thermometer, a stirrer, and a nitrogen inlet tube, 39 parts of sorbitol, 61 parts of oleic acid, and 50 parts of xylene as a solvent were charged and were reacted at 180° C. in a nitrogen gas flow for 3 hours while distilling away the generated water. The pressure of the reaction system was reduced at the time when the acid value (mg KOH/g) reached less than 1 to remove xylene to obtain an esterification product (O-4) of sorbitol and oleic acid.

### Manufacturing Example 18

In a reaction vessel equipped with a cooling tube, a thermometer, a stirrer, and a nitrogen inlet tube, 68 parts of polyoxyethylene monomethyl ether (manufactured by Sigma-Aldrich Co. LLC, Mn=550), 32 parts of oleic acid, and 50 parts of xylene as a solvent were charged and were reacted at 180° C. in a nitrogen gas flow for 3 hours while distilling away the generated water. The pressure of the reaction system was reduced at the time when the acid value (mg KOH/g) reached less than 1 to remove xylene to obtain an oleic acid polyethylene glycol ester (O-5).

### Manufacturing Example 19

In a reaction vessel equipped with a cooling tube, a thermometer, a stirrer, and a nitrogen inlet tube, 44 parts of polyoxyethylene monomethyl ether (manufactured by Kanto Chemical Co., Ltd., Polyethylene Glycol Monomethyl Ether 220, Mn=220), 56 parts of oleic acid, and 50 parts of xylene as a solvent were charged and were reacted at 180° C. in a nitrogen gas flow for 3 hours while distilling away the generated water. The pressure of the reaction system was reduced at the time when the acid value (mg KOH/g) reached less than 1 to remove xylene to obtain an oleic acid polyethylene glycol ester (O-6).

### Comparative Manufacturing Examples 1 to 3

Solvent solutions of polyurethane resins (P′-1) to (P′-3) were obtained as in manufacturing example 2 except that the raw materials used and the amounts thereof were changed to those shown in Table 1.

### Comparative Manufacturing Example 4

In a reaction vessel equipped with a cooling tube, a thermometer, a stirrer, and a nitrogen inlet tube, 59 parts of polypropylene glycol diglycidyl ether (epoxy equivalent: 201 g/equivalent) was charged. The inside of the vessel was then purged with nitrogen and was heated to 70° C., and 38 parts of di-n-butylamine was then dropwise added thereto using a dropping device. After the completion of the dropping, they were reacted at 90° C. for 10 hours. After the completion of the reaction, disappearance of the absorption peak near 842 cm⁻¹ originated from the epoxy group of the reaction product was confirmed using an infrared spectrophotometer to obtain a tertiary amino group-containing polyol (amine value and hydroxyl value were both 165.5 mg KOH/g).

In a reaction vessel equipped with a cooling tube, a thermometer, a stirrer, and a nitrogen inlet tube, 219.8 parts of 1,4-butanediol, 254.0 parts of neopentyl glycol, 362.0 parts of terephthalic acid, 318.6 parts of adipic acid, and 2 parts of titanium diisopropoxy bistriethanol aminate as a condensation catalyst were charged and were reacted at 200° C. in a nitrogen gas flow for 3 hours while distilling away the generated water and were further reacted under reduced pressure of 0.5 to 2.5 kPa at 200° C. for 6 hours. The reaction product was taken out from the reaction vessel at the time when the acid value (mg KOH/g) reached less than 1 to obtain a polyester diol having a hydroxyl value (mg KOH/g) of 58.9.

In a simple pressurized reactor equipped with a stirrer and a heating device, 48.6 parts of polycarbonate diol (manufactured by UBE Corporation, ETERNACOLL UH-200), 24.2 parts of the polyester polyol (neopentyl glycol/1,4-butanediol/terephthalic acid/adipic acid copolymer), 5.8 parts of the polyol having a tertiary amino group, 19.3 parts of dicyclohexylmethane-4,4-diisocyanate (MDI-H) as a polyisocyanate component, and 100 parts of ethyl acetate as an organic solvent for reaction were charged and were stirred at 70° C. for 12 hours to perform urethanization reaction. After the reaction, 3.2 parts of “Amino Silane A1100” (manufactured by ENEOS NUC Corporation, γ-aminopropyl triethoxysilane) was added thereto, and reaction was performed for 1 hour to produce an ethyl acetate solution of a urethane prepolymer. Subsequently, 1.0 parts of hydrazine hydrate was added to the urethane prepolymer solution, and chain extension reaction was performed for 1 hour. Subsequently, 134.6 parts of ethyl acetate and 2.1 parts of dimethyl sulfate were added thereto, and the mixture was maintained at 50° C. for 4 hours. Then, 227.3 parts of water was added thereto while stirring at 200 rpm to disperse the mixture. The ethyl acetate was distilled away under reduced pressure at 60° C. over 2 hours. The solid concentration was adjusted to 16.7 wt % with water to obtain a dispersion liquid of polyurethane resin (P′-4).

The compositions and physical properties of the polyurethane resins are shown in Table 1.

TABLE 1

| | | | Manufacturing | Manufacturing | Manufacturing | Manufacturing | Manufacturing |
|---|---|---|---|---|---|---|---|
| | | | example 1 | example 2 | example 3 | example 4 | example 5 |
| Polyurethane resin | | | P-1 | P-2 | P-3 | P-4 | P-5 |
| Polyurethane | A | Polyester polyol | 45.1 | — | — | — | — |
| resin | | Diethylene glycol/terephthalic | | | | | |
| charging parts | | acid/isophthalic acid copolymer | | | | | |
| by weight | | Polycarbonate polyol | — | 45.1 | — | — | 29.6 |
| | | JBE Corp. ETERNACOLL UH-200 | | | | | |
| | | Polycarbonate polyol | — | — | 45.1 | — | — |
| | | Mitsubishi Chemical Corp., | | | | | |
| | | BENEBIOL | | | | | |
| | | NL2010DB | | | | | |
| | | Polycarbonate polyol | — | — | — | 44.8 | — |
| | | UBE Corp., ETERNACOLL UC-100 | | | | | |
| | | Polycarbonate polyol | — | — | — | — | — |
| | | Sanyo Chemical Industries, Ltd. | | | | | |
| | | SANNIX PP-600 | | | | | |
| | | Polycarbonate polyol | — | — | — | — | — |
| | | Asahi Kasei Corp., DURANOL T565 | | | | | |
| | | Polyester polyol | — | — | — | — | — |
| | | Neopentyl glycol/1,4- | | | | | |
| | | butanediol/terephthalic acid/adipic acid | | | | | |
| | | copolymer | | | | | |
| | | 3-Methyl-1,5-pentanediol | 3.6 | 3.6 | 3.6 | 0.4 | 4.6 |
| | | 1,4-butanediol | — | — | — | — | — |
| | | Dimethylol propionic acid | — | — | — | — | — |
| | a1-1 | N-Methyldiethanolamine | 7.5 | 7.5 | 7.5 | 7.5 | — |
| | | N-Stearyldiethanolamine | — | — | — | — | 22.3 |
| | | 3-(Diethylamine)-1,2-propanediol | — | — | — | — | — |
| | | Polyoxyalkylene alkylamine | — | — | — | — | — |
| | | Sanyo Chemical Industries, Ltd., | | | | | |
| | | PUREMEEL CCS-80 | | | | | |
| | | Reaction product of polypropylene glycol | — | — | — | — | — |
| | | glycidyl ether and di-n-butylamine | | | | | |
| | a1-2 | Dimethyl sulfate | 6.9 | 6.9 | 6.9 | 6.9 | 6.9 |
| | | Diethyl sulfate | — | — | — | — | — |
| | B | MDI-H | 36.9 | 36.9 | 36.9 | 40.4 | 36.6 |
| | | TD | — | — | — | — | — |
| | THF | | 100 | 100 | 100 | 100 | 100 |
| | Ethyl acetate | | — | — | — | — | — |
| | sophorone diamine | | | | | | |
| | Hydrazine hydrate | | | | | | |
| | Water | | | | | | |
| Quaternary ammonium salt compound weight rate (wt %) (a1-1 + | | | 14.4 | 14.4 | 14.4 | 14.4 | 29.2 |
| a1-2)/(A + a1-1 + a1-2 + B) | | | | | | | |
| | | | Manufacturing | Manufacturing | Manufacturing | Manufacturing | Manufacturing |
| | | | example 6 | example 7 | example 8 | example 9 | example 10 |
| Polyurethane resin | | | P-6 | P-7 | P-8 | P-9 | P-10 |
| Polyurethane | A | Polyester polyol | — | — | — | — | — |
| resin | | Diethylene glycol/terephthalic | | | | | |
| charging parts | | acid/isophthalic acid copolymer | | | | | |
| by weight | | Polycarbonate polyol | 45.1 | 16.2 | 44.2 | 45.3 | 24.5 |
| | | JBE Corp. ETERNACOLL UH-200 | | | | | |
| | | Polycarbonate polyol | — | — | — | — | — |
| | | Mitsubishi Chemical Corp., | | | | | |
| | | BENEBIOL | | | | | |
| | | NL2010DB | | | | | |
| | | Polycarbonate polyol | — | — | — | — | — |
| | | UBE Corp., ETERNACOLL UC-100 | | | | | |
| | | Polycarbonate polyol | — | — | — | — | — |
| | | Sanyo Chemical Industries, Ltd. | | | | | |
| | | SANNIX PP-600 | | | | | |
| | | Polycarbonate polyol | — | — | — | — | — |
| | | Asahi Kasei Corp., DURANOL T565 | | | | | |
| | | Polyester polyol | — | — | — | — | — |
| | | Neopentyl glycol/1,4- | | | | | |
| | | butanediol/terephthalic acid/adipic acid | | | | | |
| | | copolymer | | | | | |
| | | 3-Methyl-1,5-pentanediol | 3.6 | 5.2 | 3.4 | 5.4 | 1.4 |
| | | 1,4-butanediol | — | — | — | — | — |
| | | Dimethylol propionic acid | — | — | — | — | — |
| | a1-1 | N-Methyldiethanolamine | — | — | 7.3 | 6.3 | 14.9 |
| | | N-Stearyldiethanolamine | — | — | — | — | — |
| | | 3-(Diethylamine)-1,2-propanediol | 7.5 | — | — | — | — |
| | | Polyoxyalkylene alkylamine | — | 34.2 | — | — | — |
| | | Sanyo Chemical Industries, Ltd., | | | | | |
| | | PUREMEEL CCS-80 | | | | | |
| | | Reaction product of polypropylene glycol | — | — | — | — | — |
| | | glycidyl ether and di-n-butylamine | | | | | |
| | a1-2 | Dimethyl sulfate | 6.9 | 7 | — | 6.0 | — |
| | | Diethyl sulfate | — | — | 9.3 | — | 17 |
| | B | MDI-H | 36.9 | 37.4 | 35.8 | 37 | 42.2 |
| | | TD | — | — | — | — | — |
| | THF | | 100 | 100 | 100 | 100 | 100 |
| | Ethyl acetate | | — | — | — | — | — |
| | sophorone diamine | | | | | | |
| | Hydrazine hydrate | | | | | | |
| | Water | | | | | | |
| Quaternary ammonium salt compound weight rate (wt %) (a1-1 + | | | 14.4 | 41.2 | 16.6 | 12.3 | 31.9 |
| a1-2)/(A + a1-1 + a1-2 + B) | | | | | | | |
| | | | | | | Comparative | Comparative |
| | | | Manufacturing | Manufacturing | Manufacturing | manufacturing | manufacturing |
| | | | example 11 | example 12 | example 13 | example 1 | example 2 |
| Polyurethane resin | | | P-11 | P-12 | P-13 | P'-1 | P'-2 |
| Polyurethane | A | Polyester polyol | — | — | — | — | — |
| resin | | Diethylene glycol/terephthalic | | | | | |
| charging parts | | acid/isophthalic acid copolymer | | | | | |
| by weight | | Polycarbonate polyol | 51.6 | — | — | 67.1 | — |
| | | JBE Corp. ETERNACOLL UH-200 | | | | | |
| | | Polycarbonate polyol | — | — | — | — | — |
| | | Mitsubishi Chemical Corp., | | | | | |
| | | BENEBIOL | | | | | |
| | | NL2010DB | | | | | |
| | | Polycarbonate polyol | — | 31.8 | 6.7 | — | — |
| | | UBE Corp., ETERNACOLL UC-100 | | | | | |
| | | Polycarbonate polyol | — | 3.3 | — | — | — |
| | | Sanyo Chemical Industries, Ltd. | | | | | |
| | | SANNIX PP-600 | | | | | |
| | | Polycarbonate polyol | — | — | — | — | 59.1 |
| | | Asahi Kasei Corp., DURANOL T565 | | | | | |
| | | Polyester polyol | — | — | — | — | — |
| | | Neopentyl glycol/1,4- | | | | | |
| | | butanediol/terephthalic acid/adipic acid | | | | | |
| | | copolymer | | | | | |
| | | 3-Methyl-1,5-pentanediol | 5 | 0.6 | 0.1 | — | — |
| | | 1,4-butanediol | — | — | — | 0.5 | — |
| | | Dimethylol propionic acid | — | — | — | 4.9 | 5.4 |
| | a1-1 | N-Methyldiethanolamine | 7.4 | 10.6 | 1.0 | — | — |
| | | N-Stearyldiethanolamine | — | — | — | — | — |
| | | 3-(Diethylamine)-1,2-propanediol | — | — | — | — | — |
| | | Polyoxyalkylene alkylamine | — | — | — | — | — |
| | | Sanyo Chemical Industries, Ltd., | | | | | |
| | | PUREMEEL CCS-80 | | | | | |
| | | Reaction product of polypropylene glycol | — | — | — | — | — |
| | | glycidyl ether and di-n-butylamine | | | | | |
| | a1-2 | Dimethyl sulfate | 7.8 | 11.4 | 1.0 | — | — |
| | | Diethyl sulfate | — | — | — | — | — |
| | B | MDI-H | — | 38.9 | 6.0 | 27.5 | 35.5 |
| | | TD | 28.2 | 1.7 | — | — | — |

| | | | | | |
|---|---|---|---|---|---|
| THF | 100 | 100 | 15 | 100 | 100 |
| Ethyl acetate | — | — | — | — | — |
| sophorone diamine | | | | 0.64 | |
| Hydrazine hydrate | | | | | |
| Water | | | | 84.4 | |

| | | | | | |
|---|---|---|---|---|---|
| Quaternary ammonium salt compound weight rate (wt %) (a1-1 + | 15.2 | 22.1 | 14.4 | 0 | 0 |
| a1-2)/(A + a1-1 + a1-2 + B) | | | | | |

### Manufacturing Example Q-1

In the vessel of a pigment disperser (TSU-6U, manufactured by IMEX Co., Ltd.), 30 parts of the solvent solution of polyurethane resin (P-1) produced in manufacturing example 1 and 120 parts of tetrahydrofuran were added, followed by stirring until the resin was uniformly dissolved. Subsequently, 10 parts of a cyan pigment (manufactured by BASF SE, Heliogen Blue D7088) and 350 parts of glass beads (ASGB-320, manufactured by AS ONE Corporation) were added to the solution and were then dispersed for 4 hours while passing cooling water of 4° C. through the jacket. While stirring the obtained dispersion slurry at 200 rpm, 100 parts of water was added thereto to disperse the mixture. To the obtained dispersion, 0.64 parts of isophoronediamine (IPDA) as an extender was added while stirring to perform extension reaction for 30 minutes. The tetrahydrofuran was distilled away under reduced pressure at 60° C. over 2 hours, and the glass beads were removed by filtering. The solid concentration was adjusted to 25 wt % with water to obtain a pigment aqueous dispersion (Q-1).

### Manufacturing Examples Q-2 to Q-25

Pigment aqueous dispersions (Q-2) to (Q-25) were obtained as in manufacturing example Q-1 except that the raw materials used and the amounts thereof were changed to those shown in Tables 2-1 to 2-3.

### Manufacturing Example Q-26

In the vessel of a pigment disperser (TSU-6U, manufactured by IMEX Co., Ltd.), 30 parts of the solvent solution of polyurethane resin (P-4) produced in manufacturing example 4, 50 parts of tetrahydrofuran, and 0.5 parts of oleic acid polyethylene glycol ester (O-6) produced in manufacturing example 19 were added, followed by stirring until the resin was uniformly dissolved. To the obtained solution, 1.51 parts of isophoronediamine (IPDA) as an extender was added while stirring to perform extension reaction for 30 minutes. Subsequently, 10 parts of a cyan pigment (manufactured by BASF SE, Heliogen Blue D7088) and 140 parts of glass beads (ASGB-320, manufactured by AS ONE Corporation) were added thereto and then dispersed for 3 hours while passing cooling water of 4° C. through the jacket. While stirring the obtained dispersion slurry at 200 rpm, 100 parts of water was added thereto to disperse the mixture. The tetrahydrofuran was distilled away under reduced pressure at 60° C. over 2 hours, and the glass beads were removed by filtering. The solid concentration was adjusted to 25 wt % with water to obtain a pigment aqueous dispersion (Q-26).

### Manufacturing Example Q-27

In the vessel of a pigment disperser (TSU-6U, manufactured by IMEX Co., Ltd.), 90 parts of a dispersion liquid of the polyurethane resin (P-13) produced in manufacturing example 13, 0.5 parts of oleic acid polyethylene glycol ester (O-6) produced in manufacturing example 19, 10 parts of a cyan pigment (manufactured by BASF SE, Heliogen Blue D7088), and 140 parts of glass beads (ASGB-320, manufactured by AS ONE Corporation) were added and then dispersed for 3 hours while passing cooling water of 4° C. through the jacket. Subsequently, the glass beads were removed by filtering, and the solid concentration was adjusted to 25 wt % with water to obtain a pigment aqueous dispersion (Q-27).

### Comparative Manufacturing Examples Q-1 to Q-3

Pigment aqueous dispersions (Q′-1) to (Q′-3) were obtained as in manufacturing example 1 except that the raw materials used and the amounts thereof were changed to those shown in Table 2-4.

### Comparative Manufacturing Example Q-4

In the vessel of a pigment disperser (TSU-6U, manufactured by IMEX Co., Ltd.), 90 parts of a dispersion liquid of the polyurethane resin (P′-4) produced in comparative manufacturing example 4, 10 parts of a cyan pigment (manufactured by BASF SE, Heliogen Blue D7088), and 140 parts of glass beads (ASGB-320, manufactured by AS ONE Corporation) were added and were then dispersed for 3 hours while passing cooling water of 4° C. through the jacket. Subsequently, the glass beads were removed by filtering, and the solid concentration was adjusted to 25 wt % with water to obtain a pigment aqueous dispersion (Q′-4).

The blending amounts of the pigment aqueous dispersions obtained in manufacturing examples and comparative manufacturing examples are shown in Table 2-4.

TABLE 2-1

| | | | Manufacturing | Manufacturing | Manufacturing | Manufacturing |
|---|---|---|---|---|---|---|
| | | | example Q-1 | example Q-2 | example Q-3 | example Q-4 |
| Pigment dispersion | | | Q-1 | Q-2 | Q-3 | Q-4 |
| Pigment | Pigment | Cyan pigment | 10 | 10 | 10 | 10 |
| dispersion | | BASF Heliogen Blue D 7088 | | | | |
| charging parts | | Magenta pigment | — | — | — | — |
| by weight | | BASE | | | | |
| | | Cinquasia_Magenta_D_4550J | | | | |
| | | Yellow pigment | — | — | — | — |
| | | BASF Palitol Yellow D 1115J | | | | |
| | | Black pigment | — | — | — | — |
| | | Orion Engineered Carbons | | | | |
| | | NIPEX_160IQ | | | | |
| | | White pigment | — | — | — | — |
| | | Sakai Chemical Industry CO., | | | | |
| | | Ltd., R21 | | | | |
| | Solvent solution or | (P-1) | 30 | — | — | — |
| | dispersion of urethane | (P-2) | — | 30 | — | — |
| | resin (P) | (P-3) | — | — | 30 | — |
| | | (P-4) | — | — | — | 30 |
| | | (P-5) | — | — | — | — |
| | | (P-6) | — | — | — | — |
| | | (P-7) | — | — | — | — |
| | | (P-8) | — | — | — | — |
| | | \|(P-9) | — | — | — | — |
| | | (P-10 | — | — | — | — |
| | | (P-11) | — | — | — | — |
| | | (P-12) | — | — | — | — |
| | | (P-13) | — | — | — | — |
| | | (P'-1) | — | — | — | — |
| | | (P'-2) | — | — | — | — |
| | | (P'-3) | — | — | — | — |
| | | (P'-4) | — | — | — | — |
| | Neutralizing agent | Neutralizing agent (triethylamine) | — | — | — | — |
| | | Neutralizing agent (lactic acid) | — | — | — | — |
| | Extender | Extender (isophorone diamine) | 0.64 | 0.64 | 0.64 | 0.64 |
| | | Diethylene triamine | — | — | — | — |
| | | Hydrazine hydrate | — | — | — | — |
| | Nonionic surfactant | (O-1) | — | — | — | — |
| | | (O-2) | — | — | — | — |
| | | (O-3) | — | — | — | — |
| | | (O-4) | — | — | — | — |
| | | (O-5) | | | | |
| | | (O-6) | | | | |
| | Water | | | | | |

| | | | Manufacturing | Manufacturing | Manufacturing |
|---|---|---|---|---|---|
| | | | example Q-5 | example Q-6 | example Q-7 |
| Pigment dispersion | | | Q-5 | Q-6 | Q-7 |
| Pigment | Pigment | Cyan pigment | 10 | 10 | 10 |
| dispersion | | BASF Heliogen Blue D 7088 | | | |
| charging parts | | Magenta pigment | — | — | — |
| by weight | | BASE | | | |
| | | Cinquasia_Magenta_D_4550J | | | |
| | | Yellow pigment | — | — | — |
| | | BASF Palitol Yellow D 1115J | | | |
| | | Black pigment | — | — | — |
| | | Orion Engineered Carbons | | | |
| | | NIPEX_160IQ | | | |
| | | White pigment | — | — | — |
| | | Sakai Chemical Industry CO., | | | |
| | | Ltd., R21 | | | |
| | Solvent solution or | (P-1) | — | — | — |
| | dispersion of urethane | (P-2) | — | — | — |
| | resin (P) | (P-3) | — | — | — |
| | | (P-4) | — | — | — |
| | | (P-5) | 30 | — | — |
| | | (P-6) | — | 30 | — |
| | | (P-7) | — | — | 30 |
| | | (P-8) | — | — | — |
| | | \|(P-9) | — | — | — |
| | | (P-10 | — | — | — |
| | | (P-11) | — | — | — |
| | | (P-12) | — | — | — |
| | | (P-13) | — | — | — |
| | | (P'-1) | — | — | — |
| | | (P'-2) | — | — | — |
| | | (P'-3) | — | — | — |
| | | (P'-4) | — | — | — |
| | Neutralizing agent | Neutralizing agent (triethylamine) | — | — | — |
| | | Neutralizing agent (lactic acid) | — | — | — |
| | Extender | Extender (isophorone diamine) | 0.64 | 0.64 | 0.64 |
| | | Diethylene triamine | — | — | — |
| | | Hydrazine hydrate | — | — | — |
| | Nonionic surfactant | (O-1) | — | — | — |
| | | (O-2) | — | — | — |
| | | (O-3) | — | — | — |
| | | (O-4) | — | — | — |
| | | (O-5) | — | — | — |
| | | (O-6) | — | — | — |
| | Water | | 100 | 100 | 100 |
| | | | Manufacturing | Manufacturing | Manufacturing |
| | | | example Q-8 | example Q-9 | example Q-10 |
| Pigment dispersion | | | Q-8 | Q-9 | Q-10 |
| Pigment | Pigment | Cyan pigment | 10 | 10 | 10 |
| dispersion | | BASF Heliogen Blue D 7088 | | | |
| charging parts | | Magenta pigment | — | — | — |
| by weight | | BASE | | | |
| | | Cinquasia_Magenta_D_4550J | | | |
| | | Yellow pigment | — | — | — |
| | | BASF Palitol Yellow D 1115J | | | |
| | | Black pigment | — | — | — |
| | | Orion Engineered Carbons | | | |
| | | NIPEX_160IQ | | | |
| | | White pigment | — | — | — |
| | | Sakai Chemical Industry CO., | | | |
| | | Ltd., R21 | | | |
| | Solvent solution or | (P-1) | — | — | — |
| | dispersion of urethane | (P-2) | — | — | — |
| | resin (P) | (P-3) | — | — | — |
| | | (P-4) | — | — | — |
| | | (P-5) | — | — | — |
| | | (P-6) | — | — | — |
| | | (P-7) | — | — | — |
| | | (P-8) | 30 | — | — |
| | | \|(P-9) | — | 30 | — |
| | | (P-10 | — | — | 30 |
| | | (P-11) | — | — | — |
| | | (P-12) | — | — | — |
| | | (P-13) | — | — | — |
| | | (P'-1) | — | — | — |
| | | (P'-2) | — | — | — |
| | | (P'-3) | — | — | — |
| | | (P'-4) | — | — | — |
| | Neutralizing agent | Neutralizing agent (triethylamine) | — | — | — |
| | | Neutralizing agent (lactic acid) | — | — | — |
| | Extender | Extender (isophorone diamine) | 0.64 | 0.64 | 0.64 |
| | | Diethylene triamine | — | — | — |
| | | Hydrazine hydrate | — | — | — |
| | Nonionic surfactant | (O-1) | — | — | — |
| | | (O-2) | — | — | — |
| | | (O-3) | — | — | — |
| | | (O-4) | — | — | — |
| | | (O-5) | — | — | — |
| | | (O-6) | — | — | — |
| | Water | | 100 | 100 | 100 |

TABLE 2-2

| | | | Manufacturing | Manufacturing | Manufacturing | Manufacturing |
|---|---|---|---|---|---|---|
| | | | example Q-11 | example Q-12 | example Q-13 | example Q-14 |
| Pigment dispersion | | | Q-11 | Q-12 | Q-13 | Q-14 |
| Pigment | Pigment | Cyan pigment | — | — | — | — |
| dispersion | | BASF Heliogen Blue D 7088 | | | | |
| charging parts | | Magenta pigment | — | 10 | — | — |
| by weight | | BASF | | | | |
| | | Cinquasia_Magenta_D_4550J | | | | |
| | | Yellow pigment | — | — | 10 | — |
| | | BASF Palitol Yellow D 1115. | | | | |
| | | Black pigment | 10 | — | — | 10 |
| | | Orion Engineered Carbons | | | | |
| | | NIPEX_160IQ | | | | |
| | | White pigment | — | — | — | — |
| | | Sakai Chemical Industry Co., Ltd., R21 | | | | |
| | Solvent solution or | (P-1) | | | | |
| | dispersion of urethane | (P-2) | — | 30 | 30 | 30 |
| | resin (P) | (P-3) | — | — | — | — |
| | | (P-4) | — | — | — | — |
| | | (P-5) | — | — | — | — |
| | | (P-6) | — | — | — | — |
| | | (P-7) | — | — | — | — |
| | | (P-8) | — | — | — | — |
| | | (P-9) | — | — | — | — |
| | | (P-10) | — | — | — | — |
| | | (P-11) | 30 | — | — | — |
| | | (P-12 | — | — | — | — |
| | | (P-13) | — | — | — | — |
| | | (P'-1) | — | — | — | — |
| | | (P'-2) | — | — | — | — |
| | | (P'-3) | — | — | — | — |
| | | (P'-4) | — | — | — | — |
| | Neutralizing agent | Neutralizing agent (triethylamine) | — | — | — | — |
| | | Neutralizing agent (lactic acid) | — | — | — | — |
| | Extender | Extender (isophorone diamine) | 0.64 | 0.64 | 0.64 | 0.64 |
| | | Diethylene triamine | — | — | — | — |
| | | Hydrazine hydrate | — | — | — | — |
| | Nonionic surfactant | (O-1) | — | — | — | — |
| | | (O-2) | — | — | — | — |
| | | (O-3) | — | — | — | — |
| | | (O-4) | — | — | — | — |
| | | (O-5) | — | — | — | — |
| | | (O-6) | — | — | — | — |
| | Water | | 100 | 100 | 100 | 100 |

| | | | Manufacturing | Manufacturing | Manufacturing |
|---|---|---|---|---|---|
| | | | example Q-15 | example Q-16 | example Q-17 |
| Pigment dispersion | | | Q-15 | Q-16 | Q-17 |
| Pigment | Pigment | Cyan pigment | — | 10 | 10 |
| dispersion | | BASF Heliogen Blue D 7088 | | | |
| charging parts | | Magenta pigment | — | — | — |
| by weight | | BASF | | | |
| | | Cinquasia_Magenta_D_4550J | | | |
| | | Yellow pigment | — | — | — |
| | | BASF Palitol Yellow D 1115. | | | |
| | | Black pigment | — | — | — |
| | | Orion Engineered Carbons | | | |
| | | NIPEX_160IQ | | | |
| | | White pigment | 10 | — | — |
| | | Sakai Chemical Industry Co., Ltd., R21 | | | |
| | Solvent solution or | (P-1) | | | |
| | dispersion of urethane | (P-2) | 30 | — | — |
| | resin (P) | (P-3) | — | 30 | 30 |
| | | (P-4) | — | — | — |
| | | (P-5) | — | — | — |
| | | (P-6) | — | — | — |
| | | (P-7) | — | — | — |
| | | (P-8) | — | — | — |
| | | (P-9) | — | — | — |
| | | (P-10) | — | — | — |
| | | (P-11) | — | — | — |
| | | (P-12 | — | — | — |
| | | (P-13) | — | — | — |
| | | (P'-1) | — | — | — |
| | | (P'-2) | — | — | — |
| | | (P'-3) | — | — | — |
| | | (P'-4) | — | — | — |
| | Neutralizing agent | Neutralizing agent (triethylamine) | — | — | — |
| | | Neutralizing agent (lactic acid) | — | — | — |
| | Extender | Extender (isophorone diamine) | 0.64 | 0.64 | 0.64 |
| | | Diethylene triamine | — | — | — |
| | | Hydrazine hydrate | — | — | — |
| | Nonionic surfactant | (O-1) | — | 0.5 | — |
| | | (O-2) | — | — | 0.5 |
| | | (O-3) | — | — | — |
| | | (O-4) | — | — | — |
| | | (O-5) | — | — | — |
| | | (O-6) | — | — | — |
| | Water | | 100 | 100 | 100 |
| | | | Manufacturing | Manufacturing | Manufacturing |
| | | | example Q-18 | example Q-19 | example Q-20 |
| Pigment dispersion | | | Q-18 | Q-19 | Q-20 |
| Pigment | Pigment | Cyan pigment | 10 | 10 | 10 |
| dispersion | | BASF Heliogen Blue D 7088 | | | |
| charging parts | | Magenta pigment | — | — | — |
| by weight | | BASF | | | |
| | | Cinquasia_Magenta_D_4550J | | | |
| | | Yellow pigment | — | — | — |
| | | BASF Palitol Yellow D 1115. | | | |
| | | Black pigment | — | — | — |
| | | Orion Engineered Carbons | | | |
| | | NIPEX_160IQ | | | |
| | | White pigment | — | — | — |
| | | Sakai Chemical Industry Co., Ltd., R21 | | | |
| | Solvent solution or | (P-1) | | | |
| | dispersion of urethane | (P-2) | | | |
| | resin (P) | (P-3) | 30 | 30 | 30 |
| | | (P-4) | — | — | — |
| | | (P-5) | — | — | — |
| | | (P-6) | — | — | — |
| | | (P-7) | — | — | — |
| | | (P-8) | — | — | — |
| | | (P-9) | — | — | — |
| | | (P-10) | — | — | — |
| | | (P-11) | — | — | — |
| | | (P-12 | — | — | — |
| | | (P-13) | — | — | — |
| | | (P'-1) | — | — | — |
| | | (P'-2) | — | — | — |
| | | (P'-3) | — | — | — |
| | | (P'-4) | — | — | — |
| | Neutralizing agent | Neutralizing agent (triethylamine) | — | — | — |
| | | Neutralizing agent (lactic acid) | — | — | — |
| | Extender | Extender (isophorone diamine) | 0.64 | 0.64 | 0.64 |
| | | Diethylene triamine | — | — | — |
| | | Hydrazine hydrate | — | — | — |
| | Nonionic surfactant | (O-1) | — | — | — |
| | | (O-2) | — | — | — |
| | | (O-3) | 0.5 | — | — |
| | | (O-4) | — | 0.5 | — |
| | | (O-5) | — | — | 0.5 |
| | | (O-6) | — | — | — |
| | Water | | 100 | 100 | 100 |

TABLE 2-3

| | | | Manufacturing | Manufacturing | Manufacturing | Manufacturing |
|---|---|---|---|---|---|---|
| | | | example Q-21 | example Q-22 | example Q-23 | example Q-24 |
| Pigment dispersion | | | Q-21 | Q-22 | Q-23 | Q-24 |
| Pigment | Pigment | Cyan pigment | 10 | — | — | — |
| dispersion | | BASF Heliogen Blue D 7088 | | | | |
| charging parts | | Magenta pigment | — | 10 | — | — |
| by weight | | BASE | | | | |
| | | Cinquasia_Magenta_D_4550J | | | | |
| | | Yellow pigment | — | — | 10 | — |
| | | BASF Palitol Yellow D 1115J | | | | |
| | | Black pigment | — | — | — | 10 |
| | | Orion Engineered Carbons | | | | |
| | | NIPEX_160IQ | | | | |
| | | White pigment | — | — | — | — |
| | | Sakai Chemical Industry Co., Ltd., R21 | | | | |
| | Solvent solution or | (P-1) | — | — | — | — |
| | dispersion of urethane | (P-2) | — | — | — | — |
| | resin (P) | (P-3) | — | — | — | — |
| | | (P-4) | — | — | — | — |
| | | (P-5) | — | — | — | — |
| | | (P-6) | — | — | — | — |
| | | (P-7) | — | — | — | — |
| | | (P-8) | — | — | — | — |
| | | (P-9) | — | — | — | — |
| | | (P-10) | — | — | — | — |
| | | (P-11) | — | — | — | — |
| | | (P-12) | 30 | 30 | 30 | 30 |
| | | (P-13) | — | — | — | — |
| | | (P'-1) | — | — | — | — |
| | | (P'-2) | — | — | — | — |
| | | (P'-3) | — | — | — | — |
| | | (P'-4) | | | | |
| | Neutralizing agent | Neutralizing agent (triethylamine) | — | — | — | — |
| | | Neutralizing agent (lactic acid) | | | | |
| | Extender | Extender (isophorone diamine) | 0.64 | 0.64 | 0.64 | 0.64 |
| | | Diethylene triamine | — | — | — | — |
| | | Hydrazine hydrate | — | — | — | — |
| | Nonionic surfactant | (O-1) | — | — | — | — |
| | | (O-2) | — | — | — | — |
| | | (O-3) | — | — | — | — |
| | | (O-4) | — | — | — | — |
| | | (O-5) | — | — | — | — |
| | | (O-6) | 0.5 | 0.5 | 0.5 | 0.5 |
| | Water | | 100 | 100 | 100 | 100 |

| | | | Manufacturing | Manufacturing | Manufacturing |
|---|---|---|---|---|---|
| | | | example Q-25 | example Q-26 | example Q-27 |
| Pigment dispersion | | | Q-25 | Q-26 | Q-27 |
| Pigment | Pigment | Cyan pigment | — | 10 | 10 |
| dispersion | | BASF Heliogen Blue D 7088 | | | |
| charging parts | | Magenta pigment | — | — | — |
| by weight | | BASE | | | |
| | | Cinquasia_Magenta_D_4550J | | | |
| | | Yellow pigment | — | -— | — |
| | | BASF Palitol Yellow D 1115J | | | |
| | | Black pigment | — | — | — |
| | | Orion Engineered Carbons | | | |
| | | NIPEX_160IQ | | | |
| | | White pigment | 10 | — | — |
| | | Sakai Chemical Industry Co., Ltd., R21 | | | |
| | Solvent solution or | (P-1) | — | — | — |
| | dispersion of urethane | (P-2) | — | — | — |
| | resin (P) | (P-3) | — | — | — |
| | | (P-4) | — | 30 | — |
| | | (P-5) | — | — | — |
| | | (P-6) | — | — | — |
| | | (P-7) | — | — | — |
| | | (P-8) | — | — | — |
| | | (P-9) | — | — | — |
| | | (P-10) | — | — | — |
| | | (P-11) | — | — | — |
| | | (P-12) | 30 | — | — |
| | | (P-13) | — | — | 30 |
| | | (P'-1) | — | — | — |
| | | (P'-2) | — | — | — |
| | | (P'-3) | — | — | — |
| | | (P'-4) | | | |
| | Neutralizing agent | Neutralizing agent (triethylamine) | — | — | — |
| | | Neutralizing agent (lactic acid) | | | |
| | Extender | Extender (isophorone diamine) | 0.64 | 1.51 | 0.64 |
| | | Diethylene triamine | — | — | — |
| | | Hydrazine hydrate | — | — | — |
| | Nonionic surfactant | (O-1) | — | — | — |
| | | (O-2) | — | — | — |
| | | (O-3) | — | — | — |
| | | (O-4) | — | — | — |
| | | (O-5) | — | — | — |
| | | (O-6) | 0.5 | 0.5 | 0.5 |
| | Water | | 100 | 100 | |

TABLE 2-4

| | | | Comparative | Comparative | Comparative | Comparative |
|---|---|---|---|---|---|---|
| | | | manufacturing | manufacturing | manufacturing | manufacturing |
| | | | example Q-1 | example Q-2 | example Q-3 | example Q-4 |
| Pigment dispersion | | | Q'-1 | Q'-2 | Q'-3 | Q'-4 |
| Pigment dispersion | Pigment | Cyan pigment | 10 | 10 | 10 | 10 |
| charging parts | | BASF Heliogen Blue D 7088 | — | — | — | — |
| by weight | | Magenta pigment | | | | |
| | | BASF | | | | |
| | | Cinquasia_Magenta_D_4550J | | | | |
| | | Yellow pigment | — | — | — | — |
| | | BASF Palitol Yellow D 1115J | | | | |
| | | Black pigment | — | — | — | — |
| | | Orion Engineered Carbons | | | | |
| | | NIPEX_160IQ | | | | |
| | | White pigment | — | — | — | — |
| | | Sakai Chemical Industry Co., Ltd., R21 | | | | |
| | Solvent solution or | (P-1) | — | — | — | — |
| | dispersion of urethane | (P-2) | — | — | — | — |
| | resin (P) | (P-3) | — | — | — | — |
| | | (P-4) | — | — | — | — |
| | | (P-5) | — | — | — | — |
| | | (P-6) | — | — | — | — |
| | | (P-7) | — | — | — | — |
| | | (P-8) | — | — | — | — |
| | | (P-9) | — | — | — | — |
| | | (P-10) | — | — | — | — |
| | | (P-11) | — | — | — | — |
| | | (P-12) | — | — | — | — |
| | | (P-13} | — | — | — | — |
| | | (P'-1) | 30 | — | — | — |
| | | (P'-2) | — | 30 | — | — |
| | | (P'-3) | — | — | 30 | — |
| | | (P'-4) | — | — | — | 90 |
| | Neutralizing agent | Neutralizing agent (triethylamine) | 0.54 | 0.63 | — | — |
| | | Neutralizing agent (lactic acid) | — | — | 0.9 | — |
| | Extender | Extender (isophorone diamine) | 0.64 | — | 0.64 | — |
| | | Diethylene triamine | — | 1.6 | — | — |
| | | Hydrazine hydrate | — | — | — | 1.0 |
| | Nonionic surfactant | (O-1) | — | — | — | — |
| | | (O-2) | — | — | — | — |
| | | (O-3) | — | — | — | — |
| | | (O-4) | — | — | — | — |
| | | (O-5) | — | — | — | — |
| | | (O-6) | — | — | — | — |
| | Water | | 80 | 80 | 80 | — |

### Examples 1 to 30 and Comparative Examples 1 to 4

The materials of each composition shown in Tables 3-1 to 3-3 below were mixed and stirred to obtain each of inks (I-1) to (I-29) and comparative inks (I′-1) to (I′-6). Specifically, the materials were uniformly mixed, and insoluble matter was removed by filtering to prepare each ink.

TABLE 3-1

| | | | Example 1 | Example 2 | Example 3 | Example 4 | Example 5 |
|---|---|---|---|---|---|---|---|
| Ink | | | 1-1 | 1-2 | 1-3 | 1-4 | 1-5 |
| Ink jet ink composition | Pigment dispersion | Q-1 | 50 | — | — | — | — |
| | | Q-2 | — | 50 | — | — | — |
| | | Q-3 | — | — | 50 | — | — |
| | | Q-4 | — | — | — | 50 | — |
| | | Q-5 | — | — | — | — | 50 |
| | | Q-6 | — | — | — | — | — |
| | | Q-7 | — | — | — | — | — |
| | | Q-8 | — | — | — | — | — |
| | | Q-9 | — | — | — | — | — |
| | | Q-10 | — | — | — | — | — |
| | | Q-11 | — | — | — | — | — |
| | | Q-12 | — | — | — | — | — |
| | | Q-13 | — | — | — | — | — |
| | | Q-14 | — | — | — | — | — |
| | | Q-15 | — | — | — | — | — |
| | | Q-16 | — | — | — | — | — |
| | | Q-17 | — | — | — | — | — |
| | | Q-18 | — | — | — | — | — |
| | | Q-19 | — | — | — | — | — |
| | | Q-20 | — | — | — | — | — |
| | | Q-21 | — | — | — | — | — |
| | | Q-22 | — | — | — | — | — |
| | | Q-23 | — | — | — | — | — |
| | | Q-24 | — | — | — | — | — |
| | | Q-25 | — | — | — | — | — |
| | | Q-26 | — | — | — | — | — |
| | | Q-27 | — | — | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 15 | 15 | 15 |
| | solvent | BTG | 1 | 1 | 1 | 1 | 1 |
| | Surfactant | BYK348 | — | — | — | — | — |
| | | OLFINE E1010 | 0.5 | 0.5 | 0.5 | 0.5 | 0.5 |
| | Water | | Balance | Balance | Balance | Balance | Balance |
| Judgment of initial dispersibility | | | Good | Good | Good | Good | Good |
| Judgment of preservation stability | | | Good | Good | Good | Good | Good |
| Rubbing fastness (cotton fabric) | DRY | | Good | Excellent | Good | Good | Excellent |
| | WET | | Good | Good | Good | Good | Good |
| Color developing property (Image density on non-pretreated fabric) | | | Good | Good | Good | Good | Good |
| Filterability after heating | | | Good | Good | Good | Good | Good |
| Continuous printing test | | | Good | Good | Good | Excellent | Good |
| | | | Example 6 | Example 7 | Example 8 | Example 9 | Example 10 |
| Ink | | | 1-6 | 1-7 | 1-8 | 1-9 | 1-10 |
| Ink jet ink composition | Pigment dispersion | Q-1 | — | — | — | — | — |
| | | Q-2 | — | — | — | — | — |
| | | Q-3 | — | — | — | — | — |
| | | Q-4 | — | — | — | — | — |
| | | Q-5 | — | — | — | — | — |
| | | Q-6 | 50 | — | — | — | — |
| | | Q-7 | — | 50 | — | — | — |
| | | Q-8 | — | — | 50 | — | — |
| | | Q-9 | — | — | — | 50 | — |
| | | Q-10 | — | — | — | — | 50 |
| | | Q-11 | — | — | — | — | — |
| | | Q-12 | — | — | — | — | — |
| | | Q-13 | — | — | — | — | — |
| | | Q-14 | — | — | — | — | — |
| | | Q-15 | — | — | -— | — | — |
| | | Q-16 | — | — | — | — | — |
| | | Q-17 | — | — | — | — | — |
| | | Q-18 | — | — | — | — | — |
| | | Q-19 | — | — | — | — | — |
| | | Q-20 | — | — | — | — | — |
| | | Q-21 | — | — | — | — | — |
| | | Q-22 | — | — | — | — | — |
| | | Q-23 | — | — | — | — | — |
| | | Q-24 | — | — | — | — | — |
| | | Q-25 | — | — | — | — | — |
| | | Q-26 | — | — | — | — | — |
| | | Q-27 | — | — | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 15 | 15 | 15 |
| | solvent | BTG | 1 | 1 | 1 | 1 | 1 |
| | Surfactant | BYK348 | — | — | — | — | — |
| | | OLFINE E1010 | 0.5 | 0.5 | 0.5 | 0.5 | 0.5 |
| | Water | | Balance | Balance | Balance | Balance | Balance |
| Judgment of initial dispersibility | | | Good | Good | Good | Good | Good |
| Judgment of preservation stability | | | Good | Good | Good | Good | Good |
| Rubbing fastness (cotton fabric) | DRY | | Good | Good | Excellent | Good | Good |
| | WET | | Good | Good | Good | Good | Good |
| Color developing property (Image density on non-pretreated fabric) | | | Good | Good | Good | Good | Good |
| Filterability after heating | | | Good | Good | Good | Good | Good |
| Continuous printing test | | | Good | Good | Good | Good | Good |
| | | | Example 11 | Example 12 | Example 13 | Example 14 | Example 15 |
| Ink | | | I-11 | 1-12 | 1-13 | 1-14 | 1-15 |
| Ink jet ink composition | Pigment dispersion | Q-1 | — | — | — | — | — |
| | | Q-2 | — | — | — | — | — |
| | | Q-3 | — | — | — | — | — |
| | | Q-4 | — | — | — | — | — |
| | | Q-5 | — | — | — | — | — |
| | | Q-6 | — | — | — | — | — |
| | | Q-7 | — | — | — | — | — |
| | | Q-8 | — | — | — | — | — |
| | | Q-9 | — | — | — | — | — |
| | | Q-10 | — | — | — | — | — |
| | | Q-11 | 50 | — | — | — | — |
| | | Q-12 | — | 50 | — | — | — |
| | | Q-13 | — | — | 50 | — | — |
| | | Q-14 | — | — | — | 50 | — |
| | | Q-15 | — | — | — | — | 50 |
| | | Q-16 | — | — | — | — | — |
| | | Q-17 | — | — | — | — | — |
| | | Q-18 | — | — | — | — | — |
| | | Q-19 | — | — | — | — | — |
| | | Q-20 | — | — | — | — | — |
| | | Q-21 | — | — | — | — | — |
| | | Q-22 | — | — | — | — | — |
| | | Q-23 | — | — | — | — | — |
| | | Q-24 | — | — | — | — | — |
| | | Q-25 | — | — | — | — | — |
| | | Q-26 | — | — | — | — | — |
| | | Q-27 | — | — | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 15 | 15 | 15 |
| | solvent | BTG | 1 | 1 | 1 | 1 | 1 |
| | Surfactant | BYK348 | — | — | — | — | — |
| | | OLFINE E1010 | 0.5 | 0.5 | 0.5 | 0.5 | 0.5 |

| | Water | Balance | Balance | Balance | Balance | Balance |
|---|---|---|---|---|---|---|
| Judgment of initial dispersibility | | Good | Good | Good | Good | Good |
| Judgment of preservation stability | | Good | Good | Good | Good | Good |
| Rubbing fastness (cotton fabric) | DRY | Good | Excellent | Excellent | Excellent | Excellent |
| | WET | Excellent | Good | Good | Good | Good |

| | | | | | |
|---|---|---|---|---|---|
| Color developing property (Image density on non-pretreated fabric) | Good | Good | Good | Good | Good |
| Filterability after heating | Good | Good | Good | Good | Good |
| Continuous printing test | Good | Good | Good | Good | Good |

TABLE 3-2

| | | | Example 16 | Example 17 | Example 18 | Example 19 | Example 20 |
|---|---|---|---|---|---|---|---|
| Ink | | | 1-16 | 1-1 | 1-18 | 1-19 | 1-20 |
| Ink jet ink composition | Pigment dispersion | Q-1 | — | — | — | — | — |
| | | Q-2 | — | — | — | — | — |
| | | Q-3 | — | — | — | — | — |
| | | Q-4 | — | — | — | — | — |
| | | Q-5 | — | — | — | — | — |
| | | Q-6 | — | — | — | — | — |
| | | Q-7 | — | — | — | — | — |
| | | Q-8 | — | — | — | — | — |
| | | Q-9 | — | — | — | — | — |
| | | Q-10 | — | — | — | — | — |
| | | Q-11 | — | — | — | — | — |
| | | Q-12 | — | — | — | — | — |
| | | Q-13 | — | — | — | — | — |
| | | Q-14 | — | — | — | — | — |
| | | Q-15 | — | — | — | — | — |
| | | Q-16 | 50 | — | — | — | — |
| | | Q-17 | — | 50 | — | — | — |
| | | Q-18 | — | — | 50 | — | — |
| | | Q-19 | — | — | — | 50 | — |
| | | Q-20 | — | — | — | — | 50 |
| | | Q-21 | — | — | — | — | — |
| | | Q-22 | — | — | — | — | — |
| | | Q-23 | — | — | — | — | — |
| | | Q-24 | — | — | — | — | — |
| | | Q-25 | — | — | — | — | — |
| | | Q-26 | — | — | — | — | — |
| | | Q-27 | — | — | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 15 | 15 | 15 |
| | solvent | BTG | 1 | 1 | 1 | 1 | 1 |
| | Surfactant | BYK348 | — | — | — | — | — |
| | | OLFINE E1010 | 0.5 | 0.5 | 0.5 | 0.5 | 0.5 |
| | Water | | Balance | Balance | Balance | Balance | Balance |
| Judgment of initial dispersibility | | | Good | Good | Good | Good | Good |
| Judgment of preservation stability | | | Good | Good | Good | Excellent | Excellent |
| Rubbing fastness (cotton fabric) | DRY | | Excellent | Good | Good | Good | Good |
| | WET | | Good | Good | Good | Good | Good |
| Color developing property (Image density on non-pretreated fabric) | | | Good | Good | Good | Good | Good |
| Filterability after heating | | | Excellent | Good | Excellent | Good | Good |
| Continuous printing test | | | Good | Good | Good | Good | Good |
| | | | Example 21 | Example 22 | \|Example 23 | \|Example 24 | Example 25 |
| Ink | | | 1-21 | 1-22 | 1-23 | 1-24 | 1-25 |
| Ink jet ink composition | Pigment dispersion | Q-1 | — | — | — | — | — |
| | | Q-2 | — | — | — | — | — |
| | | Q-3 | — | — | — | — | — |
| | | Q-4 | — | — | — | — | — |
| | | Q-5 | — | — | — | — | — |
| | | Q-6 | — | — | — | — | — |
| | | Q-7 | — | — | — | — | — |
| | | Q-8 | — | — | — | — | — |
| | | Q-9 | — | — | — | — | — |
| | | Q-10 | — | — | — | — | — |
| | | Q-11 | — | — | — | — | — |
| | | Q-12 | — | — | — | — | — |
| | | Q-13 | — | — | — | — | — |
| | | Q-14 | — | — | — | — | — |
| | | Q-15 | — | — | — | — | — |
| | | Q-16 | — | — | — | — | — |
| | | Q-17 | — | — | — | — | — |
| | | Q-18 | — | — | — | — | — |
| | | Q-19 | — | — | — | — | — |
| | | Q-20 | — | — | — | — | — |
| | | Q-21 | 50 | — | — | — | — |
| | | Q-22 | — | 50 | — | — | — |
| | | Q-23 | — | — | 50 | — | — |
| | | Q-24 | — | — | — | 50 | — |
| | | Q-25 | — | — | — | — | 50 |
| | | Q-26 | — | — | — | — | — |
| | | Q-27 | — | — | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 15 | 15 | 15 |
| | solvent | BTG | 1 | 1 | 1 | 1 | 1 |
| | Surfactant | BYK348 | — | — | — | — | — |
| | | OLFINE E1010 | 0.5 | 0.5 | 0.5 | 0.5 | 0.5 |
| | Water | | Balance | Balance | Balance | Balance | Balance |
| Judgment of initial dispersibility | | | Good | Good | Good | Good | Good |
| Judgment of preservation stability | | | Good | Good | Good | Good | Good |
| Rubbing fastness (cotton fabric) | DRY | | Excellent | Excellent | Excellent | Excellent | Excellent |
| | WET | | Excellent | Excellent | Excellent | Excellent | Excellent |
| Color developing property (Image density on non-pretreated fabric) | | | Good | Good | Good | Good | Good |
| Filterability after heating | | | Excellent | Excellent | Excellent | Excellent | Excellent |
| Continuous printing test | | | Excellent | Excellent | Excellent | Excellent | Excellent |
| | | | Example 26 | Example 27 | Example 28 | Example 29 | Example 30 |
| Ink | | | 1-26 | 1-27 | 1-28 | 1-29 | 1-30 |
| Ink jet ink composition | Pigment dispersion | Q-1 | — | — | — | — | — |
| | | Q-2 | — | — | — | — | — |
| | | Q-3 | — | — | — | — | — |
| | | Q-4 | — | — | — | — | — |
| | | Q-5 | — | — | — | — | — |
| | | Q-6 | — | — | — | — | — |
| | | Q-7 | — | — | — | — | — |
| | | Q-8 | — | — | — | — | — |
| | | Q-9 | — | — | — | — | — |
| | | Q-10 | — | — | — | — | — |
| | | Q-11 | — | — | — | — | — |
| | | Q-12 | — | — | — | — | — |
| | | Q-13 | — | — | — | — | — |
| | | Q-14 | — | — | — | — | — |
| | | Q-15 | — | — | — | — | — |
| | | Q-16 | — | — | — | — | — |
| | | Q-17 | — | — | — | — | — |
| | | Q-18 | — | — | — | — | — |
| | | Q-19 | — | — | — | — | — |
| | | Q-20 | — | — | — | — | — |
| | | Q-21 | — | — | — | — | — |
| | | Q-22 | — | — | — | — | — |
| | | Q-23 | — | — | 50 | 50 | 50 |
| | | Q-24 | — | — | — | — | — |
| | | Q-25 | — | — | — | — | — |
| | | Q-26 | 50 | — | — | — | — |
| | | Q-27 | — | 50 | — | — | — |
| | | Q-1' | — | — | — | — | — |
| | | Q-2' | — | — | — | — | — |
| | | Q-3' | — | — | — | — | — |
| | | Q-4' | — | — | — | — | — |
| | Water-soluble organic | Glycerin | 15 | 15 | 4 | 29 | 15 |
| | solvent | BTG | 1 | 1 | 1 | 1 | 1 |
| | Surfactant | BYK348 | — | — | — | — | 0.5 |
| | | OLFINE E1010 | 0.5 | 0.5 | 0.5 | 0.5 | — |

| | Water | Balance | Balance | Balance | Balance | Balance |
|---|---|---|---|---|---|---|
| Judgment of initial dispersibility | | Good | Good | Good | Good | Good |
| Judgment of preservation stability | | Good | Good | Good | Fair | Good |
| Rubbing fastness (cotton fabric) | DRY | Good | Good | Excellent | Excellent | Excellent |
| | WET | Good | Good | Excellent | Excellent | Excellent |

| | | | | | |
|---|---|---|---|---|---|
| Color developing property (Image density on non-pretreated fabric) | Good | Good | Good | Good | Good |
| Filterability after heating | Good | Good | Excellent | Excellent | Excellent |
| Continuous printing test | Excellent | Good | Good | Excellent | Excellent |

TABLE 3-3

| | | | Comparative | Comparative | Comparative | Comparative |
|---|---|---|---|---|---|---|
| | | | Example 1 | Example 2 | Example 3 | Example 4 |
| Ink | | | l'-1 | l'-2 | l'-3 | l'-4 |
| Ink jet ink composition | Pigment dispersion | Q-1 | — | — | — | — |
| | | Q-2 | — | — | — | — |
| | | Q-3 | — | — | — | — |
| | | Q-4 | — | — | — | — |
| | | Q-5 | — | — | — | — |
| | | Q-6 | — | — | — | — |
| | | Q-7 | — | — | — | — |
| | | Q-8 | — | — | — | — |
| | | Q-9 | — | — | — | — |
| | | Q-10 | — | — | — | — |
| | | Q-11 | — | — | — | — |
| | | Q-12 | — | — | — | — |
| | | Q-13 | — | — | — | — |
| | | Q-14 | — | — | — | — |
| | | Q-15 | — | — | — | — |
| | | Q-16 | — | — | — | — |
| | | Q-17 | — | — | — | — |
| | | Q-18 | — | — | — | — |
| | | Q-19 | — | — | — | — |
| | | Q-20 | — | — | — | — |
| | | Q-21 | — | — | — | — |
| | | Q-22 | — | — | — | — |
| | | Q-23 | — | — | — | — |
| | | Q-24 | — | — | — | — |
| | | Q-25 | — | — | — | — |
| | | Q-26 | — | — | — | — |
| | | Q-27 | — | — | — | — |
| | | Q-1' | 50 | — | — | — |
| | | Q-2' | — | 50 | — | — |
| | | Q-3' | — | — | 50 | — |
| | | Q-4' | — | — | — | 50 |
| | Water-soluble | Glycerin | 15 | 15 | 15 | 15 |
| | organic solvent | BTG | 1 | 1 | 1 | 1 |
| | Surfactant | BYK348 | — | — | — | — |
| | | OLFINE E1010 | 0.5 | 0.5 | 0.5 | 0.5 |

| | Water | Balance | Balance | Balance | Balance |
|---|---|---|---|---|---|
| Judgment of initial dispersibility | | Good | Good | — | Poor |
| Judgment of preservation stability | | Good | Good | — | Poo |
| Rubbing fastness (cotton fabric) | DRY | Good | Poor | — | Good |
| | WET | Good | Poor | — | Fair |

| | | | | |
|---|---|---|---|---|
| Color developing property (Image density on non-pretreated fabric) | Poor | Poor | — | Poor |
| Filterability after heating | Good | Good | — | Fair |
| Continuous printing test | Good | Poor | — | Good |

In Tables 3-1 to 3-3, various abbreviations are as follows.
BYK348: silicone surfactant “BYK-348” (product name, manufactured by BYK JAPAN K.K.)
OLFINE E1010: acetylene surfactant “OLFINE E1010” (product name, manufactured by Nissin Chemical Industry Co., Ltd.)
Glycerin: normal boiling point: 290° C.
BTG: triethylene glycol butyl ether (normal boiling point: 272° C.)

### Evaluation Method

The methods for measuring and evaluating the obtained pigment aqueous dispersions will now be described.

### Evaluation of Initial Dispersibility

The initial dispersibility was evaluated from the results of measurement of the particle diameter of the pigment aqueous dispersion in the ink produced above and the ink viscosity.

The particle diameter of a pigment aqueous dispersion in an ink using a color pigment (cyan, magenta, yellow, or black in Examples) was evaluated by the following criteria:
Good: cumulant average diameter is 180 nm or less; and
Poor: cumulant average diameter is higher than 180 nm.

The particle diameter of a pigment aqueous dispersion in an ink using a white pigment was evaluated by the following criteria:
Good: cumulant average diameter is 300 nm or less; and
Poor: cumulant average diameter is higher than 300 nm.

The ink viscosity was evaluated by the following criteria:
Good: ink viscosity is 6.0 mPa·s or less; and
Poor: ink viscosity is higher than 6.0 mPa·s.

The initial dispersibility of each ink was evaluated from the results of measurements of particle diameter and viscosity by the following criteria:
Good: both the cumulant average diameter and the ink viscosity are Good; and
Poor: either or both the cumulant average diameter and the ink viscosity are Poor.

### Method for Measuring Particle Diameter of Pigment Aqueous Dispersion in Ink

Particle diameters were measured with a light scattering particle size distribution measuring apparatus (manufactured by Otsuka Electronics Co., Ltd., “ELSZ-1000”), and the obtained cumulant average diameter was defined as the particle diameter.

### Method for Measuring Ink Viscosity

The viscosities of inks (I-1) to (I-30) and comparative inks (I′-1), (I′-2), and (I′-4) were measured using the following measurement apparatus and conditions:
Apparatus: MCR 102 (manufactured by Anton Paar GmbH);
Jig: 75 mm cone plate;
Shear rate: 1000 l/s; and
Measurement temperature: 20° C.
   The aggregated ink (I′-3) was excluded from the analysis.

### Evaluation of Preservation Stability

Each ink was left to stand in a circulating air dryer set to a temperature of 60° C. for 5 days, and the preservation stability was evaluated from the change rates in the particle diameter of the pigment aqueous dispersion in the ink and in the ink viscosity before and after the test. The methods for calculating the change rates are shown in the following expressions:

Change rate in particle diameter of pigment aqueous dispersion in ink: (S2−S1)/S1×100(%); and

Change rate in ink viscosity: (V2−V1)/V1×100(%),
S1: particle diameter of pigment aqueous dispersion in ink before the test;
S2: particle diameter of pigment aqueous dispersion in ink after the test;
V1: ink viscosity before the test; and
V2: ink viscosity after the test.

The evaluation criteria are as follows:
Good: change rates in particle diameter and ink viscosity are both within 10%; and
Poor: change rates in particle dimeter and/or ink viscosity are above 10%.
   Method for Evaluating Dry Rubbing Fastness (Scuffing Resistance) with Cotton Fabric: Color Ink

Inks (I-1) to (I-14), (I-16) to (I-24), (I-26), and (I-27) and comparative inks (I′-1), (I′-2), and (I′-4) were printed on plain cotton broadcloth (cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

The dry rubbing fastness was evaluated in accordance with JIS L0849-2. The test pieces were rubbed back and forth 100 times with a load of 200 g. The dye transfer density to unbleached muslin No. 3 was measured at 9 points with a spectral colorimeter (manufactured by X-Rite, Inc., X-rite 938), and the average of the measurement results was defined as the dye transfer density. The dye transfer density was evaluated by the following criteria, and the results are shown in Tables 3-1 to 3-3. The lower the dye transfer density, the better the rubbing fastness.
Excellent: dye transfer density is 0.10 or less;
Good: dye transfer density is higher than 0.10 and 0.15 or less;
Fair: dye transfer density is higher than 0.15 and 0.20 or less; and
Poor: dye transfer density is higher than 0.20 and 0.30 or less.

A dye transfer density of 0.15 or less is the practical level.

Method for Evaluating Dry Rubbing Fastness (Scuffing Resistance) with Cotton Fabric: White Ink

Inks (I-15) and (I-25) were printed on black plain cotton broadcloth (black cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

The dry rubbing fastness was evaluated in accordance with JIS L0849-2. The test pieces were rubbed back and forth 100 times with a load of 200 g. The image density on the printed surface was measured at 9 points before and after the rubbing with a spectral colorimeter (manufactured by X-Rite, Inc., X-rite 938), and the average of the differences in the measurement results before and after the rubbing was defined as ΔL*. The ΔL* was evaluated by the following criteria, and the results are shown in Tables 3-1 to 3-3. The lower the ΔL*, the better the rubbing fastness.
Excellent: ΔL*≤0.3;
Good: 0.3<ΔL*≤1.0;
Fair: 1.0<ΔL*≤5.0; and
Poor: 5.0<ΔL*.
   Method for Evaluating Wet Rubbing Fastness (Scuffing Resistance) with Cotton Fabric: Color Ink

Inks (I-1) to (I-14), (I-16) to (I-24), (I-26), and (I-27) and comparative inks (I′-1), (I′-2), and (I′-4) were printed on plain cotton broadcloth (cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

The dye transfer density to unbleached muslin No. 3 was measured at 9 points with a spectral colorimeter (manufactured by X-Rite, Inc., X-rite 938), and the average of the measurement results was defined as the dye transfer density. The dye transfer density was evaluated by the following criteria, and the results are shown in Tables 3-1 to 3-3. The lower the dye transfer density, the better the rubbing fastness.
Excellent: dye transfer density is 0.20 or less;
Good: dye transfer density is higher than 0.20 and 0.25 or less;
Fair: dye transfer density is higher than 0.25 and 0.30 or less; and
Poor: dye transfer density is higher than 0.30 and 0.40 or less.

A dye transfer density of 0.25 or less is the practical level.

Method for Evaluating Wet Rubbing Fastness (Scuffing Resistance) with Cotton Fabric: White Ink

Inks (I-15) and (I-25) were printed on black plain cotton broadcloth (black cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

The image density on the printed surface was measured at 9 points before and after rubbing with a spectral colorimeter (manufactured by X-Rite, Inc., X-rite 938), and the average of the differences in the measurement results before and after the rubbing was defined as ΔL*. The ΔL* was evaluated by the following criteria, and the results are shown in Tables 3-1 to 3-3. The lower the ΔL*, the better the rubbing fastness.
Excellent: ΔL*≤0.3;
Good: 0.3<ΔL*≤1.0;
Fair: 1.0<ΔL*≤5.0; and
Poor: 5.0<ΔL*.
   Method for Evaluating Color Development Property with Cotton Fabric: Color Ink

Inks (I-1) to (I-14), (I-16) to (I-24), (I-26), and (I-27) and comparative inks (I′-1), (I′-2), and (I′-4) were printed on plain cotton broadcloth (cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

The image density was measured at 9 points with a spectral colorimeter (manufactured by X-Rite, Inc., X-rite 938), and the average of the measurement results was defined as the image density. The image density was evaluated by the following criteria, and the results are shown in Tables 3-1 to 3-3. The higher the image density, the better the color development property.
Good: image density is 1.3 or more;
Fair: image density is 1.2 or more and less than 1.3; and
Poor: image density is less than 1.2.

An image density of 1.3 or more is the practical level.

Method for Evaluating Color Development Property with Cotton Fabric: White Ink

Inks (I-15) and (I-25) were printed on black plain cotton broadcloth (black cotton: 100 mass %) with a remodeled ink jet printer of PX-G930 manufactured by Seiko Epson Corporation and were dried at 160° C. for 10 minutes to produce each test piece (21 cm×28 cm) of plain cotton broadcloth coated with a pigment and a polyurethane resin.

In order to judge the image density by the L* value, the L* was measured at 9 points with a spectral colorimeter (manufactured by X-Rite, Inc., X-rite 938), and the average of the measurement results was adopted. The L* was evaluated by the following criteria, and the results are shown in Tables 3-1 to 3-3. The higher the L*, the better the color development property.
Good: L* is 70 or more;
Fair: L* is 50 or more and less than 70; and
Poor: L* is less than 50.
   Filterability after Heating

In the evaluation of the filterability after heating, the inks were left to stand in a circulation dryer set to a temperature of 60° C. for 5 days and were filtered under reduced pressure by suction with a water aspirator (maximum degree of vacuum: about 24 mmHg). As the filter, a prefilter (φ47 mm, including 100 sheets, AP2504700/2-3055-07) and MF-Millipore membrane (cellulose-mixed ester, hydrophilic, 8.0 μm, 47 mm, white) were used. The evaluation was made based on the weight of the ink that can be passed through. The evaluation criteria are as follows. The results are shown in Tables 3-1 to 3-3.
Excellent: 300 g or more;
Good: 100 g or more and less than 300 g;
Fair: 50 g or more and less than 100 g;
Poor: less than 50 g.

### Continuous Printing Performance Test

The above manufactured inks were loaded on a remodeled ink jet printer of PX-G930 manufactured by Seiko Epson Corporation. A solid image was continuously printed at a resolution of 1440×720 dpi, and streak and unevenness were evaluated. The evaluation criteria are as follows. The results are shown in Tables 3-1 to 3-3.
Excellent: no streak and unevenness occurred for 24 hours or more;
Good: streak and unevenness occurred in 5 hours or more and less than 24 hours;
Fair: streak and unevenness occurred in 1 hour or more and less than 5 hours; and
Poor: streak and unevenness occurred in less than 1 hour.

Inks (I-1) to (I-30) are excellent in initial dispersibility and preservation stability and also excellent in scuffing resistance. In addition, they are excellent in color development property for non-pretreated cotton fabric. In comparative ink (I′-1) and (I′-2), which did not use a quaternary ammonium compound, The color development property was insufficient (Comparative Examples 1 and 2). In comparative ink (I′-3), which did not use a quaternary ammonium compound, the particles aggregated under basic conditions, and the ink initial dispersibility and preservation stability were insufficient (Comparative Example 3). In comparative ink (I′-4) in which the amount of the quaternary ammonium compound in the polyurethane resin was 7.9 parts, the initial dispersibility and preservation stability of the ink were insufficient, and the color development property was insufficient (Comparative Example 4).

What is claimed is:

1. An aqueous ink jet ink comprising a pigment aqueous dispersion, water, and a water-soluble organic solvent, wherein
the pigment aqueous dispersion contains a pigment dispersed in a polyurethane resin obtained by reaction of an active hydrogen atom-containing component and an organic polyisocyanate component,
the active hydrogen atom-containing component contains a quaternary ammonium compound,
the organic polyisocyanate component contains one or more selected from the group consisting of a linear or branched aliphatic polyisocyanate, an alicyclic polyisocyanate, and an aromatic polyisocyanate, and
a weight rate of the quaternary ammonium compound is 12 wt % or more based on the total weight of the active hydrogen atom-containing component and the organic polyisocyanate component.

2. The aqueous ink jet ink according to claim 1, wherein the quaternary ammonium compound is a compound represented by a following formula (1) and/or a compound represented by a following formula (2): 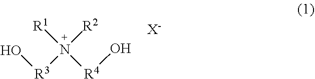
in the formula (1), R¹ and R² are each independently an alkyl group having 1 to 24 carbon atoms, R³ and R⁴ are each independently an alkylene group having 1 to 20 carbon atoms or an oxyalkylene group having 2 to 20 carbon atoms, and X⁻ is an anion; 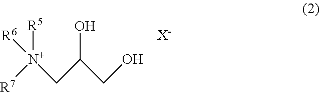
in the formula (2), R⁵, R⁶, and R⁷ are each independently an alkyl group having 1 to 4 carbon atoms, and X⁻ is an anion.

3. The aqueous ink jet ink according to claim 1, wherein the active hydrogen atom-containing component contains one or more selected from the group consisting of a polycarbonate polyol, a polyester polyol, and a polyether polyol.

4. The aqueous ink jet ink according to claim 3, wherein the polycarbonate polyol is a crystalline polycarbonate polyol.

5. The aqueous ink jet ink according to claim 1, wherein the water-soluble organic solvent includes a water-soluble organic solvent having a normal boiling point of 180° C. or more.

6. The aqueous ink jet ink according to claim 1, further comprising a surfactant.

7. The aqueous ink jet ink according to claim 6, wherein the surfactant includes a nonionic surfactant.
